(19) United States
(12) Patent Application Publication
(10) Pub. No.: US 2025/0168805 A1
(43) Pub. Date: May 22, 2025

(54) SYSTEMS AND METHODS FOR ACCURACY IMPROVEMENT FOR RTT-BASED POSITIONING

(71) Applicant: ZTE Corporation, Shenzhen (CN)

(72) Inventors: Mengzhen LI, Shenzhen (CN); Chuangxin JIANG, Shenzhen (CN); Yu PAN, Shenzhen (CN); Focai PENG, Shenzhen (CN); Qi YANG, Shenzhen (CN); Junpeng LOU, Shenzhen (CN); Juan LIU, Shenzhen (CN)

(73) Assignee: ZTE Corporation, Shenzhen (CN)

(21) Appl. No.: 18/749,157

(22) Filed: Jun. 20, 2024

Related U.S. Application Data
(63) Continuation of application No. PCT/CN2022/109799, filed on Aug. 2, 2022.

(51) Int. Cl. H04W 64/00; H04B 17/318; H04L 5/00; H04W 24/10; H04W 92/18

(52) U.S. Cl. CPC H04W 64/00; H04B 17/328; H04L 5/0051; H04W 24/10; H04W 92/18

(57) ABSTRACT

Presented are systems and methods for round trip time (RTT)-based positioning accuracy improvement. A first network node can communicate with a second network node to determine first measurement. The first measurement can correspond to a first round trip. The first network node can communicate with the second network node to determine second measurement corresponding to a second round trip. A first location of the first network node or a second location of the second network node can be determined based at least in part on the first measurement and the second measurement.

### CROSS-REFERENCE TO RELATED APPLICATION

This application claims the benefit of priority under 35 U.S.C. § 120 as a continuation of International Patent Application No. PCT/CN2022/109799, filed on Aug. 2, 2022, the disclosure of which is incorporated herein by reference in its entirety.

### TECHNICAL FIELD

The disclosure relates generally to wireless communications, including but not limited to systems and methods for accuracy improvement and round trip time (RTT)-based positioning.

### BACKGROUND

Sidelink (SL) communication refers to wireless radio communication between two or more User Equipments (UEs). In this type of communications, two or more UEs that are geographically proximate to each other can communicate without being routed to a Base Station (BS) or a core network. Data transmissions in SL communications are thus different from typical cellular network communications, which include transmitting data to a BS (e.g., uplink transmissions) and receiving data from a BS (e.g., downlink transmissions). In SL communications, data is transmitted directly from a source UE to a target UE through, for example the Unified Air Interface (e.g., PC5 interface) without passing through a BS.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium. A first network node can communicate (e.g., transfer/exchange information) with a second network node to determine first measurement. The first measurement can correspond to a first round trip. The first network node can communicate with the second network node to determine second measurement corresponding to a second round trip. A first location of the first network node and/or a second location of the second network node can be determined based at least in part on the first measurement and the second measurement.

In some arrangements, the first measurement and the second measurement can be sent to a location management function (LMF). The LMF can determine, based on at least one of the first measurement or the second measurement, the first location of the first network node or the second location of the second network node. In some arrangements, at least one of the first network node or the second network node can determine, based on at least one of the first measurement or the second measurement, the first location of the first network node or the second location of the second network node.

In some arrangements, the first network node can receive at least one of assistance data, capability request, or measurement result request from an LMF. In some implementations, at least one of: the assistance data can comprise transmission parameters, information related to a positioning method, Quality of Service (QoS) requirement of sidelink positioning reference signal (SL-PRS) to be transmitted by the first network node; the measurement results request can comprise a request for the first network node to provide information related to SL-PRS transmitted by the first network node; and/or the capability request can comprise at least one of a request for the first network node to provide information related to whether a multi-RTT is supported by the first network node or a request for the first network node to enable Multi-RTT functionalities.

In some arrangements, the first network node can send/transmit/provide at least one of capability report, assistance data request, or measurement results report to an LMF. At least one of: the assistance data request can comprise a request for transmission parameters of SL-PRS to be transmitted by the first network node; the measurement results report can comprise at least one of the first measurement or the second measurement, and each of the first measurement or the second measurement comprises at least one of signal strength, single-sided RTT (SS-RTT) reception-to-transmission time difference or SS-RTT measurement time stamp; and/or the capability report can comprise information related to whether a single-sided Multi-RTT is supported by the first network node or the Multi-RTT functionalities of the first network node.

In some arrangements, a base station (BS) (e.g., gNB, and/or TRP) can send at least one of assistance data or SL-PRS configuration data to an LMF. In some arrangements, an LMF can send at least one of SL-PRS transmission characteristic information to a base station. In some arrangements, the first network node can send a capability report comprising at least one of an indication of whether double-sided multi-RTT and/or multiple-sided multi-RTT is supported and/or an indication of a type of multi-RTT supported.

In some arrangements, the first network node can receive/obtain control information. The control information can comprise at least one of: configurations for determining at least one of the first round trip or the second round trip; triggers for determining at least one of the first round trip or the second round trip; activating at least one of determining the first round trip or determining the second round trip; and/or deactivating at least one of determining the first round trip or determining the second round trip. In some arrangements, the first network node can receive control information. The control information can comprise at least one of: indication of at least one of determining the first measurement or determining the second measurement; whether the first measurement or the second measurement is needed for feedback; and/or an identifier (ID) for both the first measurement and the second measurement.

In some arrangements, where the first network node communicates with the second network node to determine the first measurement comprises: the first network node sending a first message to the second network node; and the first network node receiving a first response to the first message from the second network node; and where the first network node communicating with the second network node to determine the second measurement comprises: the first network node receiving a second message from the second network node; and the first network node sending a second response to the second message to the second network node.

In some arrangements, where the first network node communicates with the second network node to determine the first measurement comprises: the first network node sending a first message to the second network node; and the first network node receiving a first response to the first message from the second network node; and where the first network node communicating with the second network node to determine the second measurement comprises: the first network node sending a second message to the second network node; and the first network node receiving a second response to the second message from the second network node.

In some arrangements, where the first network node communicates with the second network node to determine the first measurement comprises: the first network node sending a first message to the second network node; and the first network node receiving a first response to the first message from the second network node; and where the first network node communicates with the second network node to determine the second measurement comprises: the first network node sending a second message in response to receiving the first response to the second network node.

In some arrangements, the second message can be sent at a time when the first response is received by the first network node. In some arrangements, the first network node can receive a third message from the second network node in response to the second message. The second message and the third message can correspond to a third round trip. In some arrangements, each of the first measurement or the second measurement can comprise a reception-to-transmission time difference as a time difference between a SL-PRS receiving time and a SL-PRS transmitting time. The method can further comprise determining a total reception-to-transmission time difference for each of the first measurement or the second measurement based on a sum of a first reception-to-transmission time having a higher granularity and a second reception-to-transmission time having a lower granularity.

In some arrangements, the higher granularity can defined by a coarser resolution step and a first reporting range. The lower granularity can be defined by a finer resolution step based on a granularity factor and a second reporting range. In some arrangements, the method can comprise determining a reception-to-transmission time difference based on transmission characteristics of the first network node and the second network node. In some arrangements, the first network node can communicate preferred reply time with the second network node, applied by the first network node and the second network node before communicating to determine the first measurement and the second measurement.

In some arrangements, the first network node can send measurement results report. The measurement results report can comprise: the first measurement and the second measurement; an ID shared by the first network node and the second network node; a measurement time stamp defining time at which the first measurement or the second measurement can be determined; and/or an ID indicating a group of associated measurements.

In some arrangements, the first measurement, the second measurement, transmission configurations of signals used in determining the first measurement and the second measurement, and the measurement time stamp can be associated with one another. In some arrangements, the method can comprise determining a measurement time window within which communicating to determine the first measurement and communicating to determine the second measurement are performed. In some arrangements, the first network node can be a wireless communication device and the second network node can be a base station. In this case, the first network node can receive control information. The control information can comprise at least one of: configurations for determining an order of the first round trip and the second round trip; triggers for determining the order of the first round trip and the second round trip; activating the order of the first round trip and the second round trip; and/or deactivating the order of the first round trip and the second round trip.

In some arrangements, the first network node can be a wireless communication device and the second network node can be a base station. The method can comprise the first network node receiving control information. The control information can comprise at least one of: indication of an order for determining the first measurement or determining the second measurement; whether the first measurement or the second measurement is needed for feedback; and/or an ID for a procedure determining at least one of the first measurement or the second measurement.

In some arrangements, the first network node can be a wireless communication device and the second network node can be a base station. Each of the first measurement or the second measurement can comprise a reception-to-transmission time difference as a time difference between a signal receiving time and a signal transmitting time. In this case, the method can comprise determining a total reception-to-transmission time difference for each of the first measurement or the second measurement based on a sum of a first reception-to-transmission time having a higher granularity and a second reception-to-transmission time having a lower granularity.

In some arrangements, the first network node can communicate with a third network node to determine third measurement. The third measurement can correspond to a third round trip. The first network node can communicate with the third network node to determine fourth measurement corresponding to a fourth round trip. The first location of the first network node can be at least in part determined based on the first measurement, the second measurement, the third measurement, and the fourth measurement.

At least one aspect is directed to a system, method, apparatus, or a computer-readable medium. A network entity can determine first measurement corresponding to a first round trip of communications between a first network node and a second network node. The network entity can determine second measurement corresponding to a second round trip of communications between the first network node and the second network node. The network entity can determine a first location of the first network node or a second location of the second network node at least in part based on the first measurement and the second measurement.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates an example of RTT between a first network node and a second network node, in accordance with some embodiments of the present disclosure;

FIG. 4 illustrates an example of double-sided RTT (DS-RTT) between a first network node and a second network node, in accordance with some embodiments of the present disclosure;

FIG. 5 illustrates an example sidelink-positioning reference signal (SL-PRS) between a target UE and multiple anchor UEs, in accordance with some embodiments of the present disclosure;

FIG. 6 illustrates a flow diagram of an example method for transferring information from a location management function (LMF) to a UE, in accordance with some embodiments of the present disclosure;

FIG. 7 illustrates a flow diagram of an example method for transferring information from a UE to an LMF, in accordance with some embodiments of the present disclosure;

FIG. 8 illustrates a flow diagram of an example method for transferring information from a BS (e.g., gNB) to an LMF, in accordance with some embodiments of the present disclosure;

FIG. 9 illustrates a flow diagram of an example method for transferring information from an LMF to a BS, in accordance with some embodiments of the present disclosure;

FIG. 10 illustrates a flow diagram of an example method for communications between UEs, in accordance with some embodiments of the present disclosure;

FIG. 11 illustrates an example of DS-RTT with four messages and two different initiators, in accordance with some embodiments of the present disclosure;

FIG. 12 illustrates an example of DS-RTT with four messages and two identical/similar initiators, in accordance with some embodiments of the present disclosure;

FIG. 13 illustrates an example of DS-RTT with three messages, in accordance with some embodiments of the present disclosure;

FIG. 14 illustrates an example of asymmetric double-sided (ADS)-RTT with three messages, in accordance with some embodiments of the present disclosure;

FIG. 15 illustrates an example of multiple-sided (MS)-RTT with four SL-PRS transmissions (e.g., four messages), in accordance with some embodiments of the present disclosure;

FIG. 16 illustrates an example of SL DS-RTT, in accordance with some embodiments of the present disclosure;

FIG. 17 illustrates example slots for communication between two UEs, in accordance with some embodiments of the present disclosure;

FIG. 18 illustrates an example of triggering preferred reply times, in accordance with some embodiments of the present disclosure;

FIG. 19 illustrates a flow diagram of an example measurement group/pair including multiple measurements, in accordance with some embodiments of the present disclosure;

FIG. 20 illustrates a flow diagram of an example measurement element including multiple measurement subsets, in accordance with some embodiments of the present disclosure;

FIG. 21 illustrates a flow diagram of an example of using additional measurement to contain/include/provide DS-RTT/multiple-sided (MS)-RTT measurements, in accordance with some embodiments of the present disclosure;

FIG. 22 illustrates an example of DS-RTT between BS and UE, in accordance with some embodiments of the present disclosure;

FIG. 23 illustrates an example of different RTTs supported by hydrid positioning, in accordance with some embodiments of the present disclosure; and

FIG. 24 illustrates a flow diagram of an example method for RTT-based positioning, in accordance with an embodiment of the present disclosure.

### DETAILED DESCRIPTION

### 1. Mobile Communication Technology and Environment

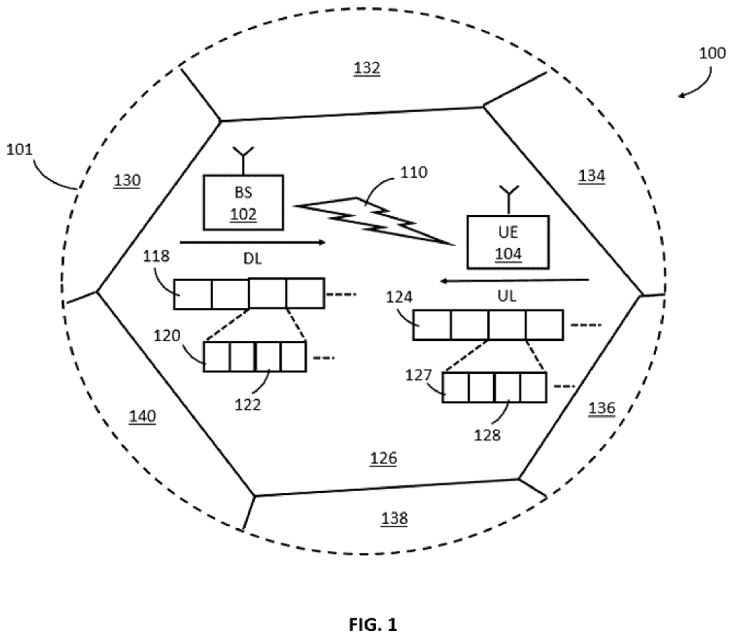

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

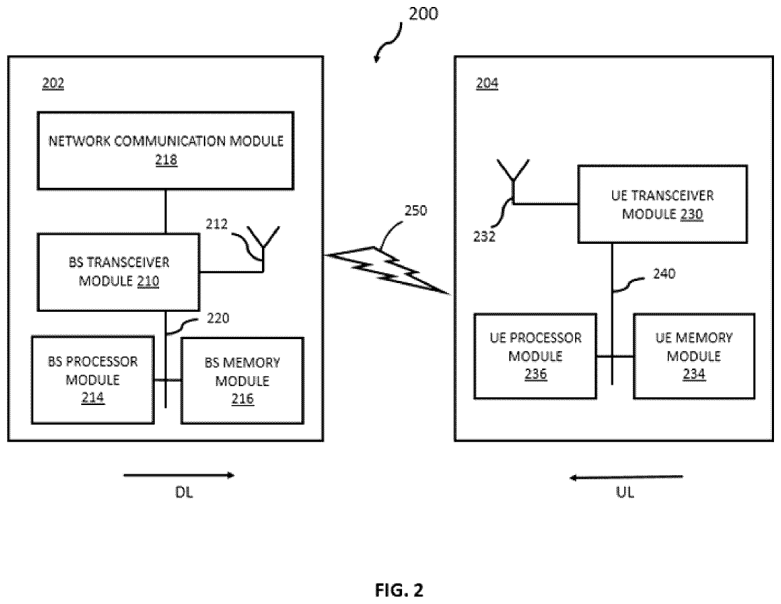

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for Accuracy Improvement for RTT-Based Positioning

In certain systems, the performance and/or positioning accuracy of a multiple round trip time (multi-RTT) positioning method/feature/technique/implementation/process may be impacted/affected by a clock shift error of at least one network node (e.g., gNB/BS 102/wireless communication node, UE 104/wireless communication device, LMF, among others). The network node may sometimes be referred to generally as a node. In some circumstances, the accuracy of multi-RTT may be further impacted when, for instance, a sidelink multi-RTT positioning is introduced due to the difference in performance between the oscillator(s) of the UE 104 and the oscillator(s) of the BS 102.

To improve or enhance the positioning accuracy (e.g., satisfying or meeting a high-accuracy positioning requirement), the systems and methods discussed herein can include processes, procedures, and/or implementations for signaling, such as double-sided RTT (DS-RTT) for Uu (e.g., Uu interface), sidelink (SL), and/or joint Uu and SL multi-RTT positioning.

In certain systems, based on or according to the specification, the multi-RTT positioning method can utilize/leverage at least one of the measurements of the time difference between the UE reception to transmission (e.g., Rx-Tx of signals by the UE 104) and/or the downlink (DL)-positioning reference signal (PRS)-reference signal received power (RSRP) of downlink signal(s) received from one or more transmission and reception points (TRPs), which can be measured by the UE 104, and/or the BS (e.g., gNB or wireless communication node) Rx-Tx time difference measurements and/or the uplink (UL)-sounding reference signal (SRS)-RSRP at one or more TRPs of uplink signals transmitted/sent/communicated/provided from the UE 104 (e.g., among other UEs 104). Further, in some systems, standards, or based on the specification, various time-based techniques may be introduced for performing ranging and localization. For example, the time-based techniques can include at least one of a single-sided two-way ranging (SS-TWR), a double-sided two-way ranging (DS-TWR), and/or a one-way ranging (OWR) or time difference of arrival (TDOA), among others. The arrangement, configuration, or implementation of the two-way ranging technique/process may be similar to an RTT. In some arrangements, the DS-TWR can be an extension of SS-TWR in which two round trip time measurements may be used and/or combined to provide/give/indicate the time-of-flight (TOF) result with a reduced error (e.g., clock shift error), such as in the presence of uncorrected/unadjusted clock frequency offset (e.g., even for relatively long or extended response delays).

As may be discussed herein, the UE 104 can correspond to, be associated with, or be a part of a vehicle (e.g., a vehicle UE), a mobile UE, a road side unit (RSU), a positioning reference unit (PRU), and/or any other types of UEs 104 that supports V2X service, sidelink communication, and/or Uu communication. The UE 104 can be with or without a known position/location (e.g., identified or unidentified position). A target UE may refer to or correspond to the UE 104 to be positioned or located. An anchor UE may correspond to the UE 104 that supports/assists with the positioning of the target UE. The TOF can refer to or indicate the propagation time for a signal transferred between two network nodes. For instance, multiplying the TOF by the speed of light can yield the distance between the two network nodes.

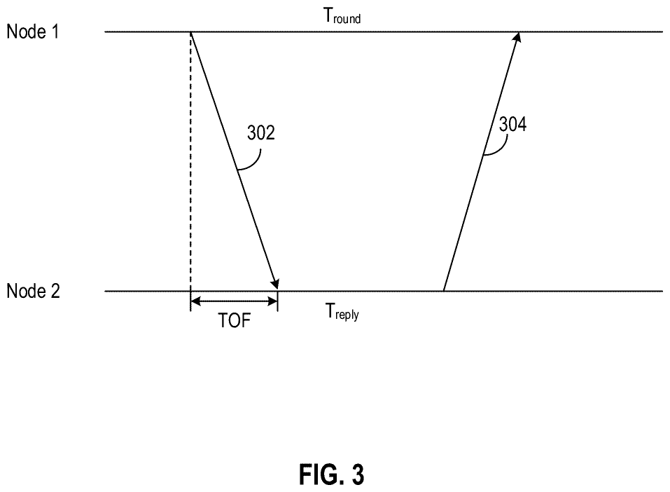

In various arrangements, a double-sided RTT (DS-RTT) for Uu, SL, and/or joint Uu and SL RTT-based positioning can be introduced/provided to improve the positioning performance or accuracy. Referring to FIG. 3, depicted is an example 300 of RTT between a first network node and a second network node. As shown, for RTT-based positioning, the first network node and/or the second network node can be the UE 104 and/or the BS 102/TRP. For example, in a certain RTT, the first network node can transmit/communicate/send a signal/message (e.g., a first signal or a first message, etc.) to the second network node (302). In this case, the TOF can represent the propagation time from the transmission instance by the first network node to the reception instance by the second network node of the signal. Subsequent to receiving the signal from the first network node, the second network node can transmit a signal (e.g., a second signal or a response message, etc.) to the first network node (304). The derivations of error comparison (e.g., for clock shift error, etc.) for various types of RTT (e.g., single or double-sided RTT) can include at least the following formulas:

$${ToF}_{SS - RTT} = \frac{1}{2} ( {T}_{round} - {T}_{reply} )$$

$$\{ \begin{matrix}{\hat{T}}_{round} = ( 1 + {e}_{node 1} ) {T}_{round} \\ {\hat{T}}_{reply} = ( 1 + {e}_{node 2} ) {T}_{reply}\end{matrix}$$

$$TO = \frac{1}{2} ( {\hat{T}}_{round} - {\hat{T}}_{reply} )$$

$${Error}_{SS - RTT} = FO - {TOF}_{SS - RTT} = {e}_{node 1} \cdot {TOF}_{SS - RTT} + \frac{1}{2} {T}_{reply} ( {e}_{node 1} - {e}_{node 2} ) \approx \frac{1}{2} {T}_{reply} ( {e}_{node 1} - {e}_{node 2} )$$

The e_{node1} and e_{node2} can represent/indicate the deviation of the respective first network node and the second network node (e.g., gNB 102/TRP and/or UE 104) from the nominal frequency (e.g., specified in the specification or configuration of the network node(s)). The frequency deviation from nominal can cause (e.g., give rise to) the clock drift/shift, which can be expressed in parts per million (ppm). In some implementations, the RTT in conjunction with FIG. 3 may represent a single-sided (SS)-RTT.

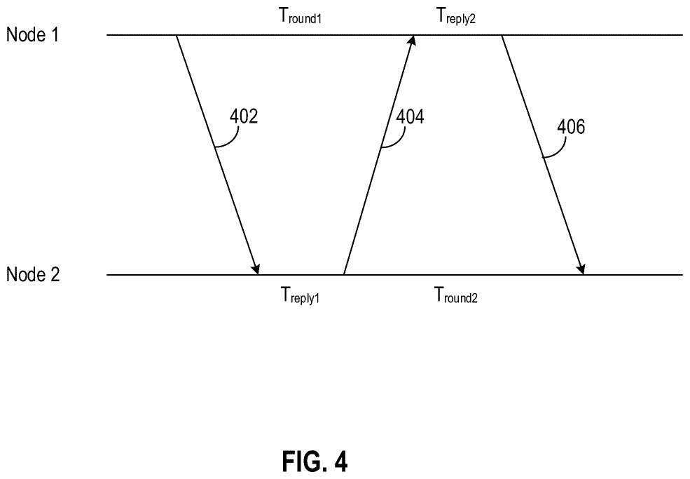

Referring to FIG. 4, depicted is an example 400 of double-sided RTT (DS-RTT) between a first network node and a second network node. In some arrangements, the operation/procedure for the DS-RTT can include three messages/signals communicated between the network nodes. For example, the first network node can transmit a first message to the second network node (402). The second network node can transmit a second message to the first network node in response to or subsequent to receiving the first message (404). The second message can be a reply/response to the first message. Subsequent to receiving the second message, the first message can transmit a third message (e.g., a second response/reply) to the second network node (406). The formulas involved in the operation of the DS-RTT can include at least the following:

$${TOF}_{DS - RTT} = \frac{1}{2} ( {T}_{round 1} - {T}_{reply 1} )$$

$${TOF}_{DS - RTT} = \frac{1}{2} ( {T}_{round 2} - {T}_{reply 2} )$$

$${TOF}_{DS - RTT} = \frac{{T}_{round 1} \times {T}_{round 2} - {T}_{reply 1} \times {T}_{reply 2}}{{T}_{round 1} \times {T}_{round 2} + {T}_{reply 1} \times {T}_{reply 2}}$$

$${Error}_{DS - RTT} = TO - {TOF}_{DS - RTT} = ( 1 - \frac{( 1 + {e}_{node 1} ) + ( 1 + {e}_{node 2} )}{2 ( 1 + {e}_{node 1} ) ( 1 + {e}_{node 2} )} ) TO = \approx \frac{( {e}_{node 1} + {e}_{node 2} )}{2} TO$$

As shown in the formulas above, the error of the RTT (e.g., in conjunction with FIG. 3) can be proportional/relative to T_{reply} (e.g., the unit can be in milliseconds), and the error of DS-RTT (e.g., in conjunction with FIG. 4) can be proportional to the TOF (e.g., the unit can be in nanoseconds). The formulas for the error of the RTT (e.g., SS-RTT) and the DS-RTT can be structured/provided as follows:

$$\{ \begin{matrix}{Error}_{SS - RTT} \approx \frac{1}{2} {T}_{reply} ( {e}_{node 1} - {e}_{node 2} ) \\ {Error}_{DS - RTT} \approx \frac{( {e}_{node 1} + {e}_{node 2} )}{2} TO\end{matrix}$$

Hence, by introducing DS-RTT, the systems and methods of the technical solution can improve/enhance/increase the positioning accuracy for various network nodes (e.g., UEs, etc.).

### Arrangement 1: SL RTT

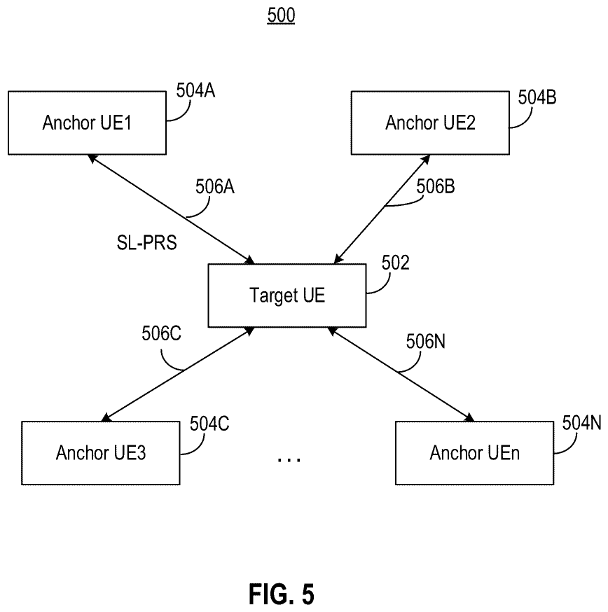

Referring to FIG. 5, depicted is an example 500 SL-PRS between a target UE (e.g., UE 502) and multiple anchor UEs (e.g., UEs 504A-N, sometimes referred to generally as UE(s) 504). In various implementations, the first network node (e.g., sometimes referred to as Node 1) and the second network node (e.g., sometimes referred to as Node 2) can be UEs 104. At least one of the network nodes can correspond to a target UE 502 and at least one other network node can correspond to an anchor UE 504. The SL multi-RTT (e.g., SL single-sided multi-RTT) positioning method can include the use of the UE Rx-Tx time difference measurements and/or SL-PRS-RSRP, and/or SL-PRS-reference signal received path power (RSRPP) of SL signals received from one or more anchor UEs 504, measured by the target UE 502, and/or the measured UE Rx-Tx time difference measurements and/or SL-SRS-RSRP, and/or SL-PRS-RSRPP at multiple anchor UEs 504 of SL signals transmitted/sent from the target UE 502. As shown, the target UE 502 and one or more anchor UEs 504 can communicate the SL-PRS between each other (506A-N). The position of the UE 104 (e.g., the target UE 502) can be determined/estimated/identified based on measurements performed/executed at the target UE 502 and/or one or more anchor UEs 504. The SL DS Multi-RTT (e.g., DS-RTT) positioning can be an extension/addition of the SL multi-RTT (e.g., SS-RTT) positioning method. For example, in SL DS-RTT, two (or more) round trip measurements can be utilized and combined to obtain/determine the distance(s) between the UEs 104.

For SL RTT (e.g., single-sided/one-way RTT and/or double-sided/two-way RTT), location management function (LMF)-based and/or UE-based positioning can be supported. For example, LMF-based RTT can include or be a positioning method/process, and UE-based RTT can be another positioning method. In LMF-based RTT, the UE 104 can provide measurements (e.g., included in at least one message or signal) to LMF. The LMF can receive the measurements from the UE 104 to perform positioning determination/calculation/estimation. In UE-based RTT, the target UE (e.g., target UE 502) can determine or compute its position and/or another UE (e.g., at least one anchor UE 504) can determine the position of the target UE. In some aspects, if the target UE does not have the capability/support to perform the positioning calculation, RTT measurements (e.g., first measurement, second measurement, etc.) can be collected from interaction(s) between the target UE and at least one other UE capable of performing the positioning calculation.

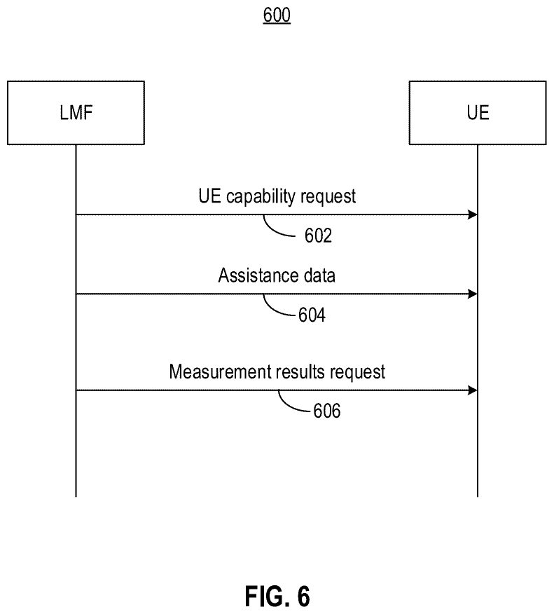

For a certain SL RTT, such as in-coverage and partial-coverage scenarios/configurations, the network can be involved in SL-PRS configuration, assisting data transmission, and/or position calculation, among others. Referring to FIG. 6, depicted is a flow diagram of an example method 600 for transferring information from an LMF to a UE 104. As shown, information can be transferred/communicated between network elements or network nodes, such as between the LMF and the UE 104. For example, the LMF can transmit at least one of a UE capability request (602), assistance data (604), and/or a measurement results request (606) to the UE 104.

For the UE capability request, the LMF can request the capability of a UE 104, such as the capability to support SL multi-RTT, and/or request SL multi-RTT positioning capabilit(ies) from the UE 104.

The assistance data can include or contain at least one of one or more SL-PRS transmission parameters of at least one UE 104 (e.g., target UE and/or anchor UE(s)), identifier(s) (ID(s)) of one or more other UEs 104 (e.g., target UE and/or anchor UE(s)), SL-PRS resource set ID, SL-PRS resource ID, time offset of direct frame number (DFN) #0/system frame number (SFN) #0 slot #0 for a UE 104 with respect to DFN #0/SFN #0 slot #0 of a reference UE and/or target UE, expected SL-PRS reference signal time difference (RSTD), expected SL-PRS RSTD uncertainty, expected SL-PRS relative time of arrival (RTOA), expected SL-PRS RTOA uncertainty, expected SL-PRS Rx-Tx time difference, expected SL-PRS Rx-Tx time difference uncertainty, SL-PRS configuration (e.g., may include the target UE and/or anchor UE(s)), subcarrier spacing of SL-PRS resource, the number of PRBs allocated for SL-PRS resource, the start of PRB index, SL-PRS comb size (e.g., resource element spacing in each symbol of the SL-PRS resource), SL-PRS AGC symbol and/or gap symbol, cyclic prefix length of SL-PRS resource, expected antenna-on-display (AoD) and/or angle-of-arrival (AoA) (e.g., in some cases, together with uncertainty), SL RTT (e.g., SS-RTT) error description/message/reason, a set of available SL-PRS configurations (e.g., can be requested by the UE 104 on-demand), specify the network area for which the assistance data is valid, response time, positioning accuracy, horizontal accuracy, vertical accuracy, timing quality, and/or synchronization reference related information, among others. The SL-PRS transmission parameter(s) can include at least one of the following: range of SL-PRS modulation and coding scheme (MCS) value, range of the number of SL-PRS sub-channels, maximum SL-PRS (re)transmission number, SL-PRS MaxTxPower, SL-PRS CRlimit, SL-PRS periodicity, SL-PRS repetition factor, number of SL-PRS symbols within a slot, and/or SL-PRS muting pattern, etc.

The measurement results request can include at least one of the following: request SL-PRS resource information (e.g., used to determine SL SS-RTT Rx-Tx time difference), request measurements (e.g., SL-PRS RSRP, first path SL-PRS RSRP, SL-PRS RSRPP, SL-PRS RSTD, and/or SL-PRS RTOA, etc.), whether to allow the UE 104 to request additional SL-PRS assistance data, SL RTT Rx-Tx time difference reporting granularity, additional paths, the maximum number of Rx-Tx time difference for SL-PRS resources per UE 104, RxTx timing error group (TEG) request, request number of SL-PRS processing sample, request the type and/or granularity of line of sight (LOS)-none line of sight (NLOS) indicator, multiple measurement instance in a single measurement report, lower Rx beam sweeping factor, measure the same SL-PRS resource with different RxTxTEG, measure the same SL-PRS resource with different RxTEG, and/or time domain behavior of measurement report (e.g., one-shot, triggered, aperiodic, semi-persistent, periodic, etc.), among others.

In some implementations, the UE 104 can provide or be requested (e.g., by the LMF) to provide information about/regarding additional paths in association with the measurements associated with SL positioning, such as in the form of a relative time difference and/or a quality value, for example. The relative time difference can refer to the additional detected path timing relative to or associated with the detected path timing of the reference resource.

In various aspects, the TEG can include, correspond to, or be associated with a Tx timing error. The Tx timing error can be the result of Tx time delay involved in, during, or associated with the transmission of a signal. This Tx timing error can be an uncalibrated Tx time delay or the remaining delay after the TRP and/or UE internal calibration and/or compensation of the Tx time delay, such as involved in the transmission of the DL-PRS and/or UL SRS signal(s). The calibration/compensation/adjustment may also include the calibration of the relative time delay between different RF chains in the same TRP and/or UE. In some cases, the calibration may consider or account for the offset of the center of the Tx antenna phase to the center of the physical antenna.

In some implementations, the TEG can include or or correspond to at least one of a UE Rx TEG, UE RxTx TEG, and/or UE Tx TEG. The UE Rx TEG can include Rx timing errors, which can be associated with the UE reporting of one or more DL measurements (e.g., RSTD) that are within a certain margin/range/frame. The UE RxTx TEG can include Rx timing errors and Tx timing errors. These timing errors can be associated with UE reporting of one or more UE Rx-Tx time difference measurements (e.g., ‘Rx timing errors+Tx timing errors’ differences) within a certain margin. The UE Tx TEG can include Tx timing errors. The Tx timing errors can be associated with UE transmissions on one or more UL SRS resources for positioning purposes within a certain margin.

In some arrangements, the TEG may be defined for or associated with the TRP. The TRP can include or be a set of geographically co-located antennas (e.g., antenna array with one or more antenna elements) supporting TP and/or RP functionality. For example, the TEG defined for the TRP can include at least one of TRP Rx TEG, TRP RxTx TEG, and/or TRP Tx TEG. The TRP Rx TEG can include Rx timing errors associated with TRP reporting of one or more UL measurements within a certain margin. The TRP RxTx TEG can include Rx timing errors and Tx timing errors associated with TRP reporting of one or more BS/gNB Rx-Tx time difference measurements (e.g., ‘Rx timing errors+Tx timing errors’ differences) within a certain margin. The TRP Tx TEG can include Tx timing errors associated with TRP transmissions on one or more DL-PRS resources within a certain margin.

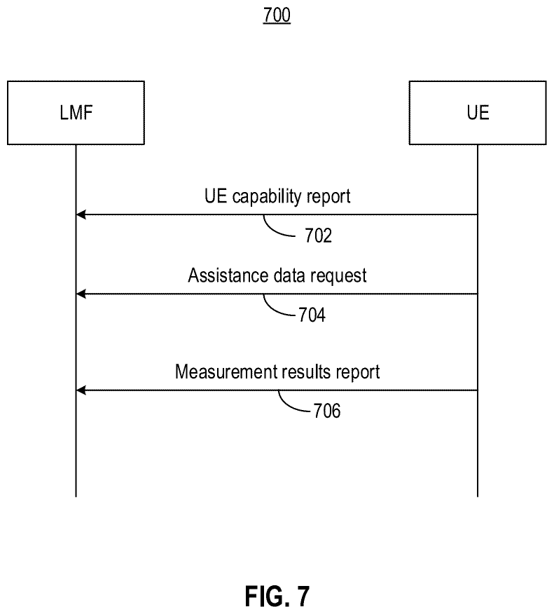

Referring to FIG. 7, depicted is a flow diagram of an example method 700 for transferring information from a UE 104 to an LMF. As shown in the UE 104 can transmit/send/provide UE capability report (702), assistance data request (704), and/or measurement results report (706) to the LMF. The information transmitted between the UE 104 and the LMF (e.g., among other network nodes) can be included/contained in or as part of at least one message.

The assistance data request can include at least one of the following: physical cell ID of the UE 104, on-demand SL-PRS requested for SL RTT (e.g., SS-RTT), expected AoA information, expected AoD information, and/or request pre-configured assistance data with area validity, among others. The measurement results report can include or correspond to at least one of the following: cell information, SL-PRS resource information, SL-PRS RSRP, SL-PRS RSRPP, Rx-Tx time difference, timestamp, timing quality, TEG information, an association between TEG and SL-PRS resource, an association between TEG and measurements, and/or additional measurements, etc. The measurement results report can correspond to one-shot, triggered, aperiodic, semi-persistent, and/or periodic.

In some implementations, the Rx-Tx time difference of the UE SL RTT may be defined or represented as T_{UE-RX}−T_{UE-TX}. The T_{UE-RX} can correspond to or indicate the UE received timing of SL subframe #i from a transmission point (TP), defined by the first detected path in time. The T_{UE-TX} can correspond to the UE transmit timing of sidelink subframe #j that may be closest in time to the subframe #i received from the TP.

In various aspects, the SL SS-RTT measurement timestamp can represent the time instance/period when the SL-PRS measurement is performed. The SL SS-RTT timestamp field may include at least one of the following information: direct frame number (DFN), slot number within the DFN, SFN, slot number within the SFN, the subframe number within a frame, slot number within a frame (e.g., related to subcarrier spacing (SCS)), symbol number within a slot, the particular/exact time location within a symbol, and/or the current coordinated universal time (UTC) time obtained from global navigation satellite system (GNSS), etc. If the synchronization source is the BS 102 (e.g., gNB), at least one of the following information can be added in the SL RTT timestamp field: the ID of the TRP which the SFN is applicable for SL-PRS transmission, physical cell ID, global cell ID, and/or absolute radio frequency channel number (ARFCN) of the TRP.

In some arrangements, the SL-PRS reference signal received power (RSRP) can represent the linear average over the power contributions (e.g., in [W] or watts) of the resource elements that carry SL-PRS reference signals configured for RSRP measurements within the predetermined/considered measurement frequency bandwidth in the configured measurement time occasions/occurrences. In some arrangements, the SL-PRS reference signal received path power (RSRPP) can represent the power of the linear average of the channel response at the i-th path delay of the resource elements that carry SL-PRS signal configured for the measurement. For instance, the SL PRS-RSRPP for the first path delay can indicate or represent the power contribution corresponding to the first detected path in time.

In various implementations, the UE 104 can indicate/provide its capability to support SL multi-RTT and/or its SL multi-RTT positioning capabilities to the location server (e.g., LMF), such as in the UE capability report. The UE capability report can include at least one of the following information: SL-PRS resource capability (e.g., maximum number of SL-PRS resources per UE 104), SL multi-RTT measurement capability, UE SL-PRS quasi co location (QCL) processing capability, SL-PRS processing capability, additional path report, periodical report, response time and its unit (e.g., second, millisecond, nanosecond, etc.), whether support AoD and/or AoA, on-demand SL-PRS request support, LOS/NLOS indicator support, RxTx TEG ID report support, and/or preconfigured assistance data validity support, among others. The SL multi-RTT measurement capability can include at least one of, for example, a maximum number of UE Rx-Tx time difference measurements corresponding to a single SL-PRS resource/resource set for positioning with each measurement corresponding to a single SL-PRS resource/resource set on frequency range 1 (FR1) and/or FR2, whether the UE 104 supports RSRP and/or RSRPP measurement for SL multi-RTT on FR1 and/or FR2, UE TEG capability, whether UE supports SL-PRS measurement in RRC-INACTIVE state, etc. The SL-PRS processing capability can include at least one of, for example, a maximum number of SL-PRS bandwidth, SL-PRS buffer type, SL-PRS processing window, the maximum number of SL-PRS resource that the UE 104 can process in a slot, measurement instance, processing samples M, duration N of SL-PRS symbols in units of milliseconds the UE 104 can process every T ms, and/or the aforementioned processing capabilities in RRC_INACTIVE state, Rx beam sweeping factor (e.g., if FR2 is supported for SL positioning), among others.

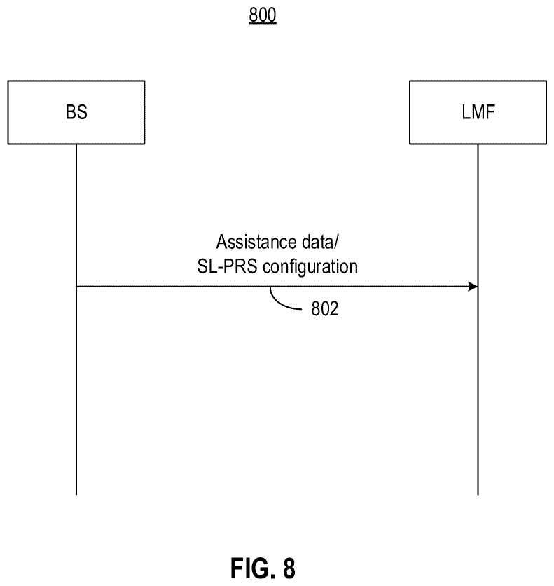

Referring to FIG. 8, depicted is a flow diagram of an example method 800 for transferring information from a BS 102 (e.g., gNB) to an LMF. As shown, the BS 102 can transmit/send/provide assistance data/SL-PRS configuration data (e.g., in a message) to the LMF (802). The assistance data/SL-PRS configuration data can include at least one of SL-PRS configuration, SL-PRS transmission characteristics, and/or its corresponding or associated UE information, etc. The SL-PRS configuration or transmission characteristics may include at least one of the following: periodicity, resource bandwidth, repetition factor, SL-PRS muting pattern, SL-PRS comb size, number of SL-PRS resource symbols, QCL information, and/or start/end time of SL-PRS transmission, among others.

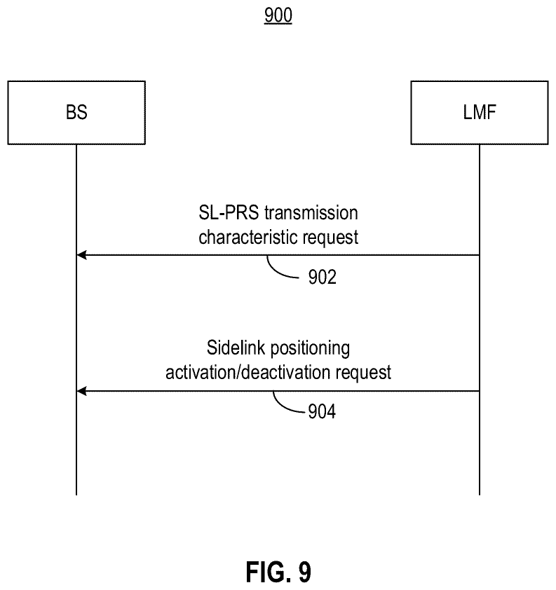

Referring to FIG. 9, depicted is a flow diagram of an example method 900 for transferring information from an LMF to a BS 102. For example, the LMF can transfer/transmit/send an SL-PRS transmission characteristic request (902) and/or SL positioning activation/deactivation request (904) to the BS 102. The SL-PRS transmission characteristic request can be a request for SL-PRS transmission characteristic information including one or more of the aforementioned information, for example. The SL positioning activation/deactivation request can correspond to or be a part of a message sent by the LMF to the BS 102 (e.g., gNB). The SL positioning activation/deactivation request can include information to cause the BS 102 (e.g., or at least one other network node) to activate/trigger/enable or deactivate/disable SL-PRS transmission by the UE 104. The BS 102 and/or the LMF can correspond to the respective one of the network nodes.

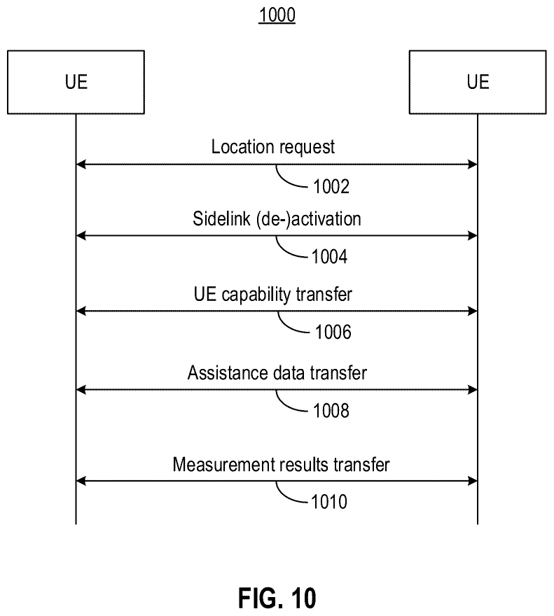

Referring to FIG. 10, depicted is a flow diagram of an example method 1000 for communications between UEs 104. For example, the communication can be between a first UE and a second UE, among other UEs 104. Under certain out-of-coverage scenarios, the network (e.g., BS 102, LMF, etc.) may not be involved in SL positioning procedure/process. In this case, the UEs 104 can communicate/transfer information to one or more other UEs 104. The information between the UEs 104 can include at least one of the following: location request (1002), SL positioning activation/deactivation request (1004), UE capability transfer (1006), assistance data transfer (1008), and/or measurement results transfer/report (1010), etc.

### Arrangement 2: SL DS-RTT Structure Signaling Procedure

In various arrangements, various DS-RTT structures and/or the extension (e.g., MS-RTT) can be introduced for SL positioning, such as DS-RTT with four messages, DS-RTT with three messages, asymmetric DS-RTT (ADS-RTT) with three messages, and/or MS-RTT, among others. The type of multi-RTT (e.g., including at least one of: SS-RTT, DS-RTT with four messages, DS-RTT with three messages, ADS-RTT, and/or MS-RTT) can be configured or requested by the LMF via LTE positioning protocol (LPP) and/or by the UE 104 via PC5-RRC, PC5-S, and/or SL-LPP (e.g., SL-LMF layer, etc.), among other high-layer signalings. For example, the UE 104 can report the DS-RTT-related capability to the LMF via LPP signaling. The LMF may request the capability information of the UE 104 for DS-RTT.

In some implementations, if the network is unavailable and/or if the UE-based DS-RTT is determined, the UE 104 may report/provide/communicate its capability to or transmit a request for the capability of at least one other UE 104 (e.g., in conjunction with ACT 1006 of FIG. 10) via at least one of: PC5-RRC signaling, PC5-S signaling, and/or SL-LPP at a new layer SL-LMF dedicated/configured used for SL positioning. The capability transfer can be unicast (e.g., transfer to another UE 104) and/or groupcast and/or broadcast signaling (e.g., transfer to a group of UEs 104).

The UE capability report can include at least one of the following information: whether the UE 104 supports SL multi-RTT and provides its SL multi-RTT positioning capability, whether the UE 104 supports DS-RTT and/or which type of DS-RTT (e.g., DS-RTT with three messages, DS-RTT with four messages, ADS-RTT, and/or others) is/are supported, SL-PRS resource capability (e.g., maximum number of SL-PRS resources per UE), SL multi-RTT measurement capability (e.g., at least one of maximum number of UE Rx-Tx time difference measurements corresponding to a single SL-PRS resource/resource set for positioning with each measurement corresponding to a single SL-PRS resource/resource set on FR1 and/or FR2, whether the UE supports RSRP and/or RSRPP measurement for sidelink Multi-RTT on FR1 and/or FR2, UE TEG capability, whether UE supports SL-PRS measurement in RRC-INACTIVE state, etc.), UE SL-PRS QCL processing capability, SL-PRS processing capability (e.g., maximum number of SL-PRS bandwidth, SL-PRS buffer type, SL-PRS processing window, the maximum number of SL-PRS resource that UE can process in a slot, measurement instance, processing samples M, duration N of SL-PRS symbols in units of milliseconds (ms) a UE can process every T ms, the aforementioned processing capabilities in RRC_INACTIVE state, and/or Rx beam sweeping factor, such as if FR2 is supported for SL positioning, etc.), additional path report, periodical report, response time, whether UE supports AoD and/or AoA, on-demand SL-PRS request support, LOS/NLOS indicator support, RxTx TEG ID report support, preconfigured assistance data validity support, and/or support of measurements based on measuring M samples for each DS-RTT, among others.

In various implementations, control information used to indicate the configuration/triggering/activation/deactivation of the first and/or the second Tx-to-Rx round trip for DS-RTT can be provided/configured. In some cases, the control information can be carried/contained/included in the higher layer signaling, the lower layer signaling, and/or both higher layer signaling and lower layer signaling, for example. In some cases, the control information may be carried in each SL-PRS transmission and/or may be used at the start of the first Tx-to-Rx round trip and/or the start of the second Tx-to-Rx round trip. The signaling (e.g., higher layer signaling and/or lower layer signaling) can be at least one of the following:
A higher layer signaling may be received from an LMF via LPP.
A higher layer signaling may be received from a BS 102 via RRC.
A higher layer signaling may be received from at least one UE 104 via PC5-RRC signaling, PC5-S signaling, application layer, and/or a new layer dedicated for SL positioning, such as SL-LMF via SL-LPP.
A lower layer signaling may be received from a BS 102 via downlink control information (DCI).
A lower layer signaling may be received from a UE 104 via SL MAC-CE and/or sidelink control information (SCI).
In some instances, if the higher layer signaling and the lower layer signaling are involved in the configuration/triggering/activation/deactivation of DS-RTT, the higher layer signaling may be used for SL-PRS configuration and/or coordinating the corresponding configuration/capabilities of the UEs 104 in DS-RTT, and the lower layer signaling may be used for initiating/activating/deactivating the first and/or second Tx-to-Rx round trip and/or potential resource indication/reservation of SL-PRS, for example.

In various aspects, the content of control information (e.g., the first and/or second Tx-to-Rx round trip indicator(s)) can be used for DS-RTT. The control information can indicate or include at least one of the following:
One or multiple bits.
The control information may include an indication of whether it is the first or the second Tx-to-Rx round trip (e.g., for determining at least one of the first round trip or the second round trip).
The control information may represent or indicate whether the RTT measurement (e.g., at least one of first measurement, second measurement, etc.) is needed or to be provided for feedback.
An ID for each DS-RTT procedure/process (e.g., for at least one of the first and/or second measurements, etc.). For instance, there may be multiple DS-RTT measurements between the target UL and at least one anchor UE. The ID can be used to distinguish at least one certain DS-RTT.

An example of the control information used for DS-RTT can be shown in the following Table 1:

TABLE 1

| Control information used | |
|---|---|
| for DS-RTT | Description |
| 0 (e.g., bit ‘00’) | Initiate the first round trip of DS-RTT, and |
| | indicate the initiating UE does not require the |
| | first Rx-Tx measurements. |
| 1 (e.g., bit ‘01’) | Initiate the first round trip of DS-RTT, and |
| | indicate the initiating UE requests for the Rx- |
| | Tx measurements to be sent back at the end of |
| | the first round trip. |
| 2 (e.g., bit ‘10’) | Trigger the second round trip of DS-RTT, and |
| | indicate the initiating UE does not require the |
| | second Rx-Tx measurement. |
| 3 (e.g., bit ‘11’) | Trigger the second round trip of DS-RTT, and |
| | request the Rx-Tx measurements to be sent |
| | back at the end of the second round trip. |

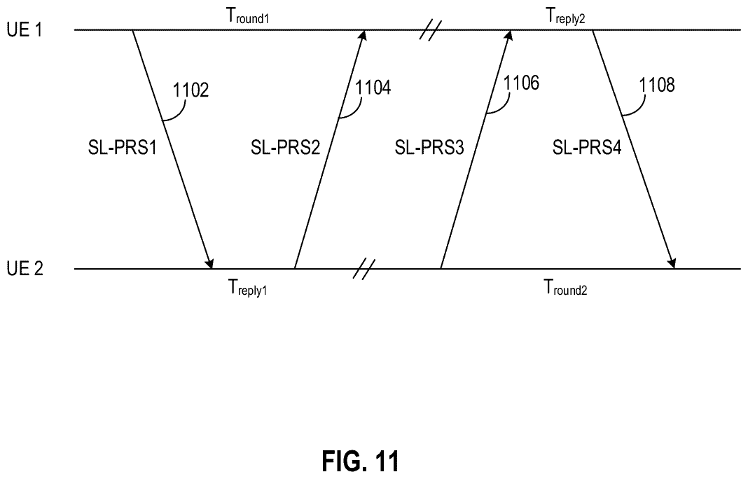

Referring to FIG. 11, depicted is an example 1100 of DS-RTT with four messages and two different initiators (e.g., the first UL and the second UL). The first UL (e.g., UL 1) may represent the first network node, and the second UE (e.g., UE 2) may represent the second network node. The first UE can initiate the first round trip of DS-RTT (e.g., first round trip measurement) by transmitting SL-PRS 1 (1102). The second UE can respond/reply/transmit with SL-PRS 2 subsequent to the transmission of the SL-PRS 1 (1104). After the first round trip (e.g., including SL-PRS 1 and SL-PRS 2), the second UE can initiate a second round trip measurement by transmitting SL-PRS 3 (1106). The first UE can respond/reply/transmit with SL-PRS 4 subsequent to the transmission of the SL-PRS 3 (1108). Hence, the first and second UEs (e.g., first and second network nodes) can be the initiators of the respective round trips of DS-RTT.

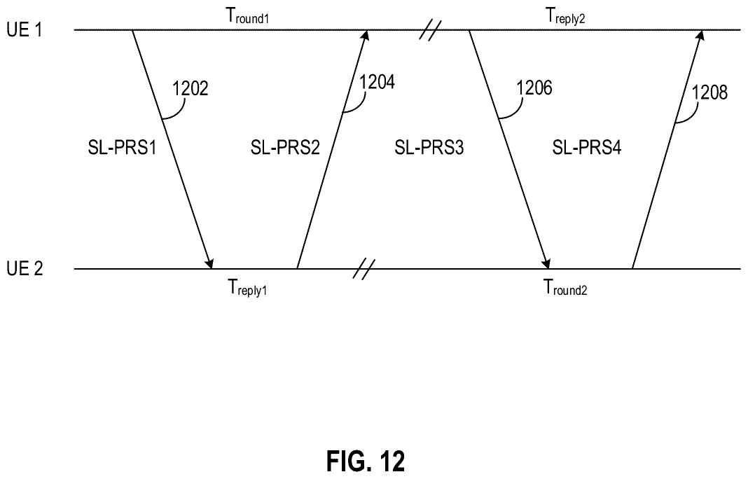

Referring to FIG. 12, depicted is an example 1200 of DS-RTT with four messages and two identical/similar initiators. In various implementations, the initiator of one or more round trips of DS-RTT for measurements can be the same UE 104 (or another network node). In this case, four messages DS-RTT can be utilized. For example, the first UE can initiate the first round trip of DS-RTT by transmitting SL-PRS 1 (1202). Subsequently, the second UE can respond/reply/transmit with SL-PRS 2 (1204). After the first round trip, the first UE can initiate the second round trip measurement by transmitting SL-PRS 3 (1206). Accordingly, the second UE can respond/reply/transmit with SL-PRS 4 (1208).

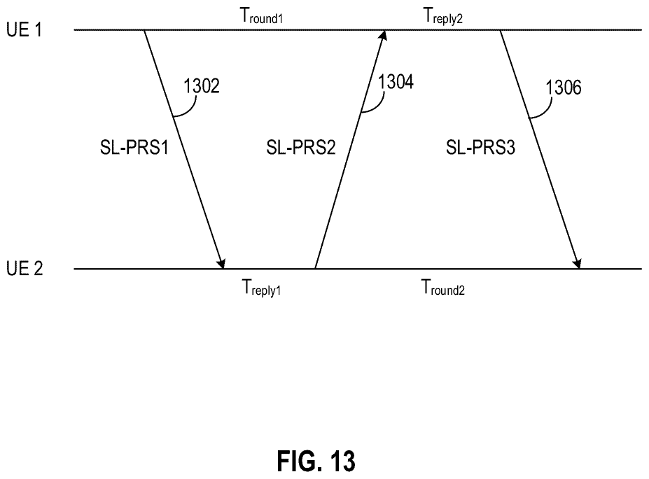

Referring to FIG. 13, depicted is an example 1300 of DS-RTT with three messages. In various arrangements, the four messages of DS-RTT can be reduced to three messages to minimize the response delay, such as by using the reply/response of the first round trip measurement (e.g., SL-PRS 2) as the initiator of the second round trip measurement. For example, the first UE can transmit the SL-PRS 1 to initiate the first round trip (1302). The second UE can receive the SL-PRS 1 and respond/reply/transmit with the SL-PRS 2, which is also used to initiate a second round trip (1304). Hence, after the SL-PRS 2, the first UE can respond/reply/transmit with SL-PRS 3 (1306).

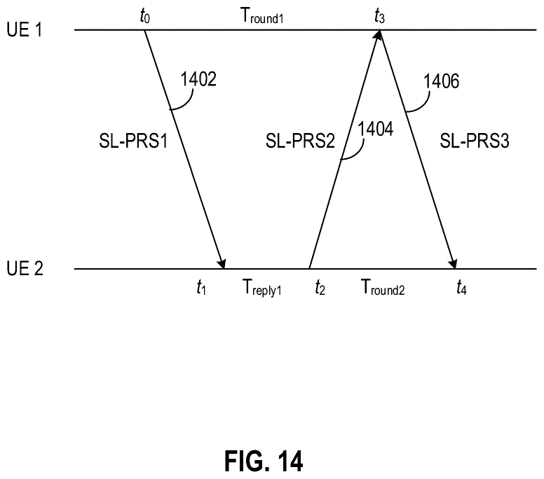

Referring to FIG. 14, depicted is an example 1400 of ADS-RTT with three messages. In some implementations, to reduce the processing delay of DS-RTT while attaining/maintaining the performance level, ADS-RTT with three messages can be utilized. In this case, in comparison to DS-RTT with three messages (e.g., shown in FIG. 13), the first UE may not wait to perform the T_{reply2} after receiving SL-PRS 2. For example, after transmitting SL-PRS 1 to initiate the first round trip (1402), the first UE can expect the second UE to reply/transmit with the SL-PRS 2 (1404). The first UE can be configured to expect SL-PRS 2 (e.g., T_{reply1}) in advance (e.g., the first UE can determine the expected time to receive a response from the second UE after SL-PRS 1 transmission), and reserve/maintain the (e.g., usable and/or suitable) SL-PRS resource at t₃ for transmission. Hence, instead of waiting to receive the T_{reply1}, the first UE can instantly transmit a reply (e.g., SL-PRS 3) at or around the expected reception time of T_{reply1}, such as t₃ in this example (1406).

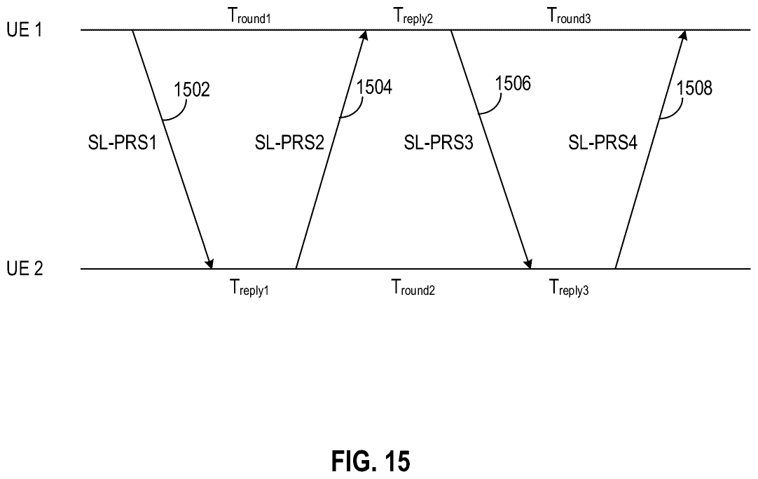

Referring to FIG. 15, depicted is an example 1500 of MS-RTT with four SL-PRS transmissions (e.g., four messages). In various configurations, increasing transmission times of the positioning messages can reduce/minimize the effects of crystal offset. For instance, when at least one ranging message (e.g., shown as SL-PRS 4) is sent from the second UE back to the first UE after the messaging sequence of DS-RTT with three messages (e.g., shown in conjunction with at least one of FIGS. 13-14, such as after SL-PRS 3), four SL-PRS transmissions can be sent in total between the UEs.

For example, the first UE can transmit a first message to initiate the first round trip (1502). The second UE can reply/transmit with a second message to initiate a second round trip (1504). The first UE can reply/transmit with a third message to initiate a third round trip (1506). The second UE can reply/transmit to the first UE with a fourth message (1508). The fourth message may or may not initiate another round trip, for example. In some implementations, the subsequent transmission(s) by at least one of the UEs (e.g., or network nodes) can be performed based on or according to the expected time to receive the respective reply (e.g., in conjunction with FIG. 14).

In further example, if real-time or efficient RTT is not required, DS-RTT can be extended/expanded to MS-RTT by including/adding/providing/implementing at least one additional round trip. In this case, the control information can be used/configured to indicate the configuration/triggering/activation/deactivation of the firth to the n-th Tx-to-Rx round trip for MS-RTT, which can have ‘n’ number of Tx-to-Rx round trips. The control information can be carried/contained in at least one of the higher layer signaling, the lower layer signaling, or the higher layer signaling and the lower layer signaling. In some cases, the control information can be carried in each SL-PRS transmission and/or used at the start of at least one Tx-to-Rx round trip. The configuration of the signaling for MS-RTT can be similar to DS-RTT (or in some cases different from the DS-RTT).

The content of control information used for MS-RT can include at least one of the following:
The first and second to the n-th Tx-to-Rx round trip indicator can indicate at least one of:
   Multiple bits.
   Control information may include an indication of its corresponding Tx-to-Rx round trip (e.g., which round trip it corresponds to).
Control information may represent whether the RTT measurement(s) (e.g., first, second, etc. measurements) is/are required/needed for feedback. Whether the total n Tx-to-Rx round trip measurements are to be reported together or reported one by one.
Each MS-RTT procedure/method can correspond to a respective ID. For instance, there may be multiple MS-RTT measurements between the target UE and at least one anchor UE. The ID can be used to distinguish at least one certain MS-RTT.

### Arrangement 3: SL DS-RTT Rx-Tx Time Difference

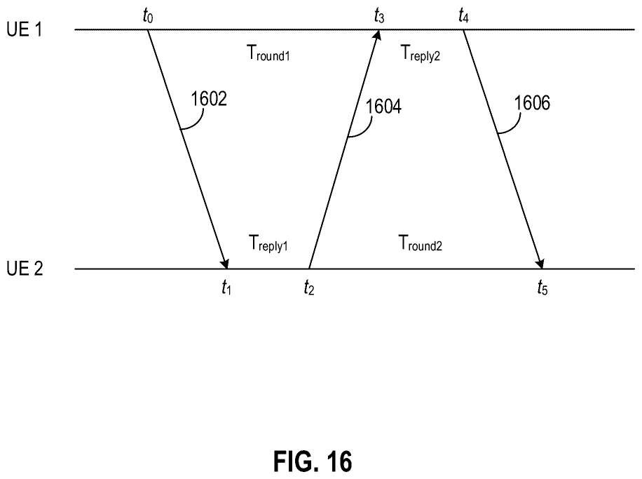

Referring to FIG. 16, depicted is an example 1600 of SL DS-RTT. As shown, if the UE Rx-Tx time difference for SL DS-RTT is calculated as the difference between the received timing and transmit timing of SL subframe, the transmit timing of t₀'s subframe can be similar or correspond to t₄'s subframe, and/or the received timing of t₁'s subframe can be similar to t₅'s subframe. The t₀, t₁, t₂, t₃, t₄, and/or t₅ can represent the UE received timing of SL-PRS and/or the UE transmit timing of SL-PRS. For example, the first UE can transmit SL-PRS 1 at to and the second UE can receive SL-PRS 1 at t₁ (1602). The second UE can transmit SL-PRS 2 at t₂ and the first UE can receive SL-PRS 2 at t₃ (1604). The first UE can transmit SL-PRS 3 at t₄ and the second UE can receive SL-PRS 3 at t₅ (1606), etc. Accordingly, the following formulas can be obtained/provided:

$${T}_{round 1} = {T}_{reply 2}$$

$${T}_{reply 1} = {T}_{round 2}$$

$$TOF = \frac{{T}_{round 1} \times {T}_{round 2} - {T}_{reply 1} \times {T}_{reply 2}}{{T}_{round 1} + {T}_{round 2} + {T}_{reply 1} + {T}_{reply 2}} = \frac{{T}_{round 1} \times {T}_{reply 1} - {T}_{reply 1} \times {T}_{round 1}}{{T}_{round 1} + {T}_{round 2} + {T}_{reply 1} + {T}_{reply 2}} = 0$$

In this case, DS-RTT and/or MS-RTT may be relatively superior to SS-RTT. Therefore, instead of using transmit/received subframe difference, the UE Rx-Tx time difference for SL DS-RTT/MS-RTT can be configured/defined as the difference between SL-PRS received timing and SL-PRS transmit timing. For example, the UE Rx-Tx time difference for SL DS-RTT/MS-RTT can be defined in multiple granularity levels (e.g., two levels). The total DS-RTT Rx-Tx time difference can be the sum of a high granularity level UE Rx-Tx time difference and a low granularity level UE Rx-Tx time difference. For example, millisecond level (e.g., high granularity level) Rx-Tx time difference can be reported along with nanosecond level (e.g., low granularity level) Rx-Tx time difference.

### 1. High Granularity Level UE Rx-Tx Time Difference

High granularity level UE Rx-Tx time difference can provide coarse-grained measurement results and/or an approximate propagation time. The (e.g., coarser) resolution step (e.g., reporting resolution) of this time difference can be at least one of the following: slot, absolute time of a slot, millisecond, and/or subframe, etc. The reporting range of the high granularity level UE Rx-Tx time difference can be related to or associated with the total slot number (e.g., Nₘax) and/or total time-domain resource (e.g., Tₘₐₓ ms) of an SL-PRS resource pool/configuration.

At least one of the following example report timing strategies can be considered/utilized:
The reporting range for the high granularity level UE Rx-Tx time difference can be configured from −0.5*Nₘₐₓ to 0.5*Nₘₐₓ slot with the resolution step of one slot.
The reporting range for the high granularity level UE Rx-Tx time difference can be configured from −0.5*Tₘₐₓ to 0.5*Tₘₐₓ ms with the resolution step of one millisecond.

### 2. Low Granularity Level UE Rx—Tx Time Difference

Low granularity level UE Rx-Tx time difference can provide finer-grained measurement results (e.g., finer resolution step). For example, time units T_{c}=1/Δfₘₐₓ·N_{f}) where Δ_{f}=480·10³ Hz and N=4096. The reporting range of this finer-grained result can be associated with the absolute time of a subframe (e.g., 1 ms) and/or a slot (e.g., 2^{-μ} ms). The resolution step of this time difference can be at least one of the following: nanosecond, multiple nanoseconds, T_{c}, and/or multiple T_{c}. At least one of the following report timing strategies can be utilized:
The reporting range for the low granularity level UE Rx-Tx time difference can be defined from −0.5 to 0.5 slot with the resolution step selected from at least one of the following: ns, 2^{k} ns, T_{c}, and/or 2^{k}*T_{c}, etc.
The reporting range for the low granularity level UE Rx-Tx time difference can be defined from −0.5 to 0.5 ms with the resolution step selected from one of the following: ns, 2^{k} ns, T_{c}, and/or 2^{k}*T_{c}, etc.

The k can represent the timing reporting granularity factor for finer-grained Rx-Tx time difference. SL DS-RTT/MS-RTT Rx-Tx time difference related parameter(s) can include at least one of the following: reporting range for the high granularity level Rx-Tx time difference, resolution step for the high granularity level Rx-Tx time difference, reporting range for the low granularity level Rx-Tx time difference, resolution step for the low granularity level Rx-Tx time difference, k value, and/or reporting strategies, among others. The parameter(s) can be configured based on/according to/using at least one of the following configurations/options:
Configured or recommended by the LMF via LPP.
Configured or recommended by the UE 104, such as at least one of:
   via PC5-RRC signaling and/or PC5-S signaling
   Through the application layer
   A new layer configured/dedicated for SL positioning (e.g., SL-LMF via SL-LPP signaling)
   Medium access control element (MAC CE).
   Physical layer signaling (e.g., SCI, etc.).
In some cases, the parameter(s) can be configured based on the implementation/configuration/specification of the UE 104 (e.g., the UE 104 that provides SL DS-RTT/MS-RTT Rx-Tx time difference in a measurement report), such that the UE 104 can perform the configuration of the parameter(s).

In some arrangements, if a parameter (e.g., timingReportinglowGranularityFactor) is used by the LMF and/or one or more other UEs 104 (e.g., anchor UE(s)) to configure or recommend k for the UE 104 (e.g., target UE), at least one of the following parameters can be applied by the UE 104:
k>=timingReportinglowGranularityFactor;
k>timingReportinglowGranularityFactor;
k=timingReportinglowGranularityFactor;
k<=timingReportinglowGranularityFactor; and/or
k<timingReportinglowGranularityFactor.

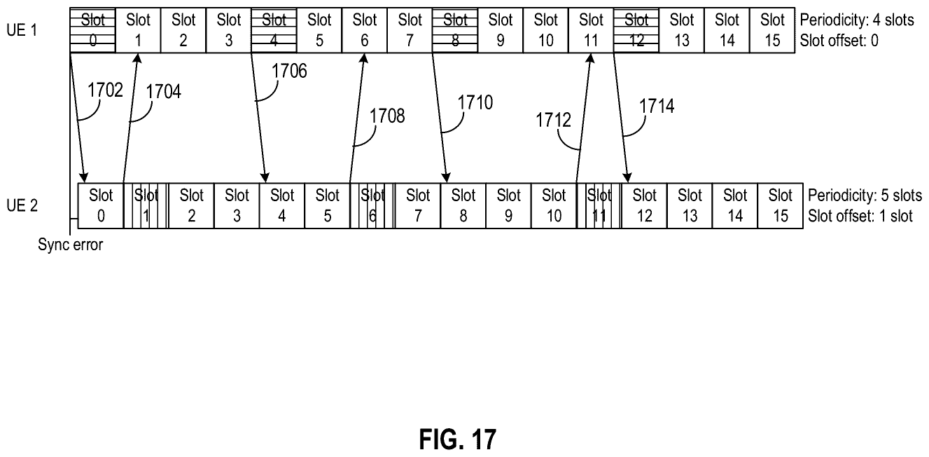

Additionally or alternatively, the UE can be configured/able to obtain SL-PRS transmission pattern/configuration of at least one other UE 104, such as through LMF via LPP, and/or directly through UE-to-UE connection (e.g., PC5-RRC signaling, PC5-S signaling, application layer, a new layer dedicated for SL positioning, such as SL-LMF via SL-LPP, MAC CE, and/or physical layer signaling, such as SCI). In some implementations, according to a certain SL communication specification, even with at least one synchronization error due to UE timing error and/or UE propagation time, two (or more) communicating UEs 104 can be synchronized at least at slot/subframe level (e.g., as shown in conjunction with FIG. 17). In some cases, the UE 104 may know or be aware of its SL-PRS transmission pattern/configuration. In this case, the slot/subframe level Rx-Tx time difference can be inferred/determined/identified from the SL-PRS transmission slot-time/slot-index/timing of the target UE and/or the anchor UE(s).

Referring to FIG. 17, depicted are example slots 1700 for communication between two UEs 104. For example, in some arrangements, the UEs 104 (e.g., UE 1 and/or UE 2) can transmit/send/provide SL-PRS at the slot boundary. As shown, the first UE can transmit each SL-PRS in slots #0 (1702), #4 (1706), #8 (1710), and/or #12 (1714) with four slots as periodicity. Further, the second UE can transmit each SL-PRS in slots #1 (1704), #6 (1708), #11 (1712), and/or #16 (not shown), etc., with 5 slots as periodicity. In this case, there may be synchronization error(s) between the first and the second UEs.

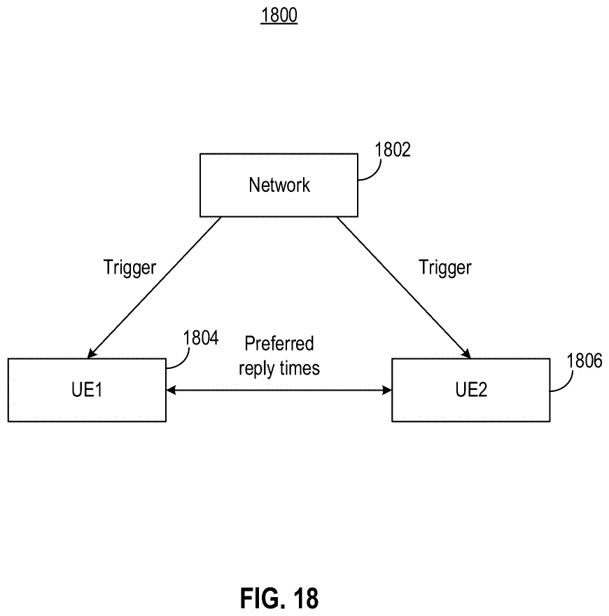

Referring to FIG. 18, depicted is an example 1800 of triggering preferred reply times. In some implementations, communication of preferred reply times for utilization by each UE 104 may occur/execute or be established prior to/before the DS-RTT/MS-RTT procedure/method/process. The information (e.g., in the communication) may include/contain at least one of the following: preferred reply times of each UE 104 (e.g., at least one or more potential reply times, where the reply time(s) of one UE 104 may not be the same as another UE 104), the time-domain location of SL-PRS transmission (e.g., including at least one of: SFN/DFN number, slot number of the DFN/SFN, and/or symbol number of the slot, etc.), range of SL-PRS MCS values, range of the number of SL-PRS sub-channels, maximum SL-PRS (re)transmission number, SL-PRS MaxTxPower, SL-PRS CRₗᵢₘᵢₜ, SL-PRS periodicity, SL-PRS repetition factor, number of SL-PRS symbols within a slot, and/or SL-PRS muting pattern, among others.

In various implementations, the exchange/communication of the preferred reply time between UEs 104 may be triggered by at least one of a UE 104 (e.g., UE 1804 and/or UE 1806) and/or a network 1802 (e.g., BS 102 and/or LMF). If the preferred reply time exchange procedure between UEs 104 is triggered by at least one UE (e.g., one of the UEs 1804, 1806), the triggered signaling may be PC5-S signaling, PC5-RRC signaling, SL LPP (e.g., new layer SL-LMF for SL positioning), MAC layer, and/or physical layer (e.g., contained in SL control signaling SCI), and/or can be reported/requested as (e.g., part of) assistance data. If the preferred reply time exchange process between UEs 104 is triggered by an LMF, the triggered signaling may be LPP or other suitable signalings. In the case of the BS 102 triggering the exchange between UEs 104, the BS 102 may use at least one of DCI and/or MAC CE to trigger the preferred reply time exchange.

In some cases, the preferred reply time(s) of two communicating UEs 104 may be transmitted/forwarded/directed from the network 1802 to the UE(s) 104. For example, LPP signaling can be used if the LMF provides the information. RRC and/or DCI signaling can be used if the BS 102 provides the information. In some aspects, the preferred reply time(s) can be initially/firstly transmitted from the BS 102 to the LMF via new radio positioning protocol A (NRPPa) signaling. Subsequently, the LMF can provide the information to at least one of the UEs 104. The preferred reply time(s) may be transferred along with the assistance data and/or as a part of the assistance data. In some implementations, when preferred reply time(s) are obtained/known/identified between the UEs 104, the receiver UE can be configured to turn on/activate at the suitable/appropriate time when the response is expected, thereby improving power conservation. In some cases, by knowing the preferred reply time(s), the respective UE(s) 104 can arrange its transmission resource reservation and/or reception resource time according to the preferred reply time(s).

### Arrangement 4: SL DS-RTT/MS-RTT Measurement Report Structure, Timestamp and Timing Delay

In various arrangements, there may be (e.g., at least two) differences between the measurements report of DS-RTT/MS-RTT and SS-RTT. For example, in DS-RTT/MS-RTT, at least one UE 104 can report two or more Rx-Tx time differences and/or other measurements for one DS-RTT/MS-RTT. The two or more Rx-Tx time differences may satisfy/meet a certain timing relationship. In another example, in at least one SL DS-RTT/MS-RTT procedure (e.g., with UE 1 and UE 2 involved in the DS-RTT/MS-RTT procedure and communicate by transmitting/receiving SL-PRS), the UE 1 and UE 2 can share the same/similar DS-RTT/MS-RTT ID. The UE 1 and/or UE 2 can help/assist the calculation entity (e.g., UE 104 and/or LMF and/or BS 102 performing the measurements or processing information) to uniquely recognize measurement report(s) from different UEs 104 in at least one DS-RTT/MS-RTT procedure. The measurement report(s) from one or more other UEs 104 in at least one DS-RTT/MS-RTT procedure can satisfy a certain timing relationship.

### SL-PRS Processing Sample(s)

In some arrangements, the UE 104 (e.g., the first UE or the second UE, etc.) may report its capability regarding the minimum/maximum number of SL-PRS processing samples (e.g., UE Rx-Tx time difference measurement samples) to at least one of the LMF, BS 102 (e.g., gNB), and/or other UEs 104 (e.g., through higher layer from at least one of: MAC CE, PC5-RRC, PC5-S, a new higher layer dedicated for SL positioning, such as SL-LMF, and/or application layer, etc.). The UE 104 may request (e.g., transmit a request) for the number of SL-PRS processing samples (e.g., UE Rx-Tx time difference measurement samples). The measurement report may include/indicate at least a sample ID. The sample ID may be included as a part of the DS-RTT/MS-RTT ID. For each of the two or more Rx-Tx measurement reports of the UE 104 in DS-RTT/MS-RTT, the pair or multiple of the reports may share/include similar or the same sample ID.

In some cases, when referring to the same or one DS-RTT/MS-RTT procedure, if various processing samples for multiple UEs 104 are the same/similar, the processing samples may share the same sample ID in the measurement report. In some other cases, the processing samples for multiple UEs 104 (e.g., involved in the same DS-RTT/MS-RTT procedure) may be different and/or include different sample IDs.

For SL DS-RTT and/or MS-RTT, the measurement results report can include or correspond to at least one of the following:
DS-RTT and/or MS-RTT ID shared by at least two UEs 104. There may be multiple DS-RTT/MS-RTT measurements between UEs 104. An ID can be shared by both UEs 104, which can be involved in one DS-RTT/MS-RTT procedure/process.
Sample ID.
A measurement list can be at least one of the following:
   The measurement list may include/contain N DS-RTT/MS-RTT measurement pairs/groups, where each DS-RTT/MS-RTT measurement pair/group can consist of/include multiple measurement elements. In this case, each measurement element can correspond to one Rx-Tx round-trip.
   The measurement list may contain N DS-RTT/MS-RTT measurements, where each DS-RTT/MS-RTT measurement can consist of multiple measurement subsets. In this case, each measurement subset can correspond to one Rx-Tx round-trip.
   The measurement list may contain N DS-RTT/MS-RTT measurements, where each DS-RTT/MS-RTT measurement can consist of multiple Rx-Tx time differences and/or some other measurements (e.g., presented as additional measurements).
   For the measurement report of at least one UE 104, N can represent the total/maximum number of anchor/assisting/neighbor/peer UEs for DS-RTT/MS-RTT.
Pair/group ID, measurement subset ID, and/or other IDs to uniquely identify certain (or whether) measurements of at least one UE 104 are configured to be packed/grouped together for DS-RTT/MS-RTT. For example, in DS-RTT with three messages, UE 1 T_{round1} and T_{reply2} including/along with their associated measurements can be reported together (e.g., grouped/paired), and/or UE 2 T_{round2} and T_{reply1} along with their associated measurements can be reported together.
   The ID can be at least 1-bit to indicate whether the measurement(s) is/are part of a group.
   The maximum number of bits for the ID can be configured/predetermined/defined by the LMF and/or by the higher layer of the UE 104 (e.g., at least one of: PC5-RRC, PC5-S, application layer, and/or SL-LMF via SL-LPP signaling, etc.). The ID can be used to indicate which group/pair/subset the respective measurements belong to/assigned to.
UE ID, which the UE 104 can report the ID information of another UE 104 it interacts/communicates during/within an RTT procedure.
Timing advance (TA) offset used by the UE 104.
Synchronization reference source of the UE 104.
SL-PRS-TxTEG (e.g., SL-PRS resource(s) associated with a particular UE Tx TEG), which may contain a timestamp to specify the end time and/or start time of SL-PRS-TxTEG element, and/or the ID of this UE Tx TEG. An example of the end time and/or start time can be provided in Table 2:

TABLE 2

| Time | t1 | t2 | t3 | t4 | t5 |
|---|---|---|---|---|---|
| TEG ID | TEG#1 | TEG#1 | TEG#2 | TEG#2 | TEG#2 |

| | | | |
|---|---|---|---|
| SL-PRS | SL-PRS#1 | SL-PRS#2 | SL-PRS#3 |

SL-PRS resource information (e.g., may be an ID to uniquely identify an SL-PRS resource associated with at least one anchor/assisting/neighbor/peer UE 104).
Cell information, physical cell ID, global cell ID, and/or ARFCN.
UE Rx-Tx time difference measurement.
Additional path timing value.
Additional path list.
Timestamp, such as described or defined herein.
Timestamp shared by the measurement group/element/subset. This timestamp can be defined as a reference timestamp or the start time of the DS-RTT/MS-RTT procedure.
Timing quality (e.g., the determination/estimation by the UE 104 of the quality of the measurement).
SL-PRS RSRP result.
TEG information, one or more of the following: UE RxTx TEG ID, UE Tx TEG ID, and/or UE Rx TEG ID, etc.
SL-PRS RSRPP.
LOS/NLOS indicator.
Additional measurements, such as at least one of the following:
   Up to a maximum number of additional measurements.
   Each additional measurement can include at least one of: cell information, SL-PRS resource information, additional SL-PRS RSRP, additional SL-PRS RSRPP, additional UE Rx-Tx time difference(s), timestamp, timing quality, TEG information, the association between TEG and SL-PRS resource, and/or the association of TEG and measurements, etc.
   The additional UE Rx-Tx time difference in the additional measurements may correspond to or be the absolute value or a result relative to the UE Rx-Tx time difference, such as described in the aforementioned.
   The additional SL-PRS RSRP may be an absolute value or a result relative to SL-PRS RSRP, such as described in the aforementioned.
   The additional SL-PRS RSRPP may be the absolute value or a result relative to SL-PRS RSRPP, such as described in the aforementioned.

For DS-RTT/MS-RTT, at least one UE 104 may be configured to transmit several SL-PRS resources and/or receive several SL-PRS resources. For one DS-RTT/MS-RTT procedure, the several SL-PRS resources for transmission can be a repeat/multiple of an (e.g., same) SL-PRS repetition or can be different SL-PRS resources. In some cases, the SL-PRS resources for the one DS-RTT/MS-RTT procedure can be in accordance with or subject to the UE capability and/or up to a maximum number of UE Rx-Tx time difference measurements corresponding to a single configured SL-PRS resource.

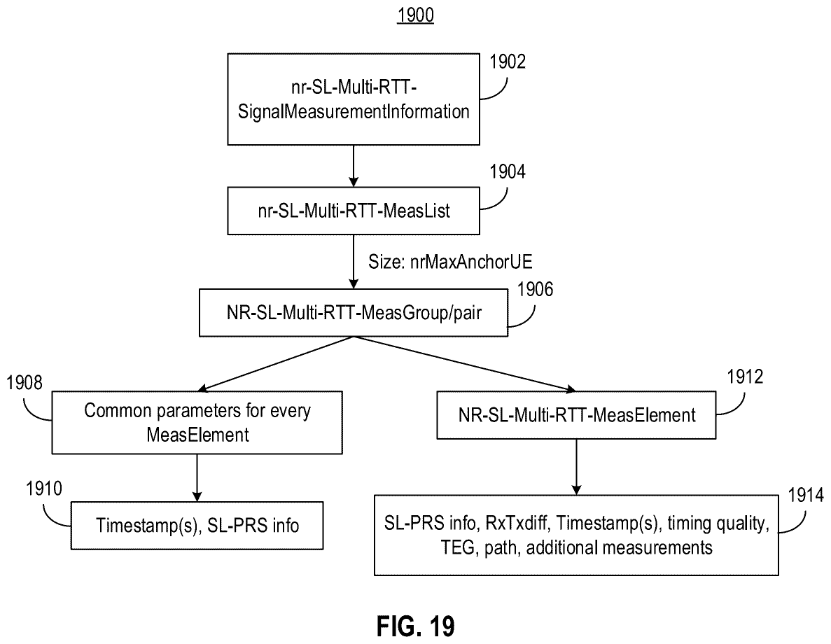

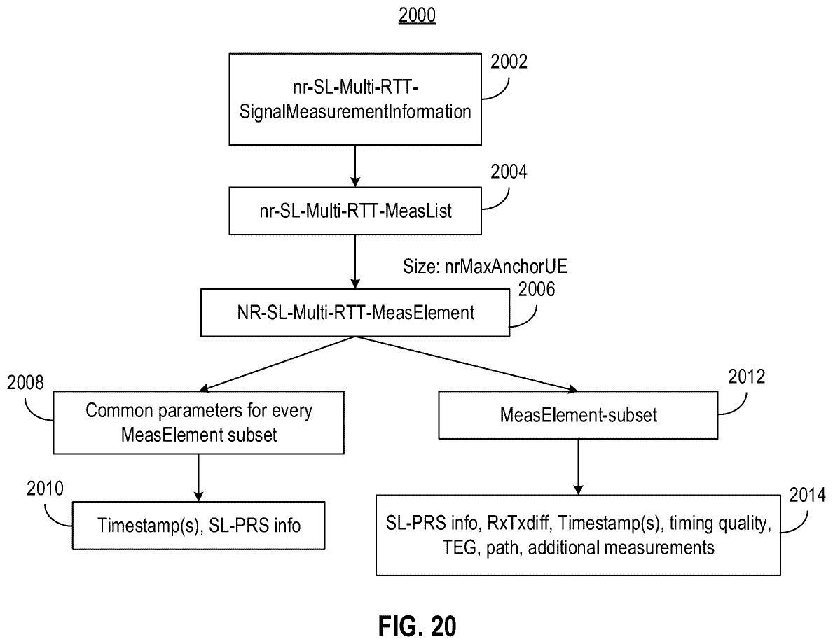

Examples for the SL DS-RTT or MS-RTT measurement report structure can be provided/shown in conjunction with FIGS. 19-21. FIG. 19 illustrates a flow diagram 1900 of an example measurement group/pair including multiple measurements. In this case, multiple measurements in at least one measurement group/pair can share one or more (e.g., common) parameters and/or at least one measurement group/pair may own/include one or more dedicated parameters (e.g., different from at least one other group/pair). FIG. 20 illustrates a flow diagram 2000 of an example measurement subset including multiple measurements. In this case, multiple measurement subsets in at least one measurement can share common parameter(s) and/or at least one measurement subset may own dedicated parameter(s) (e.g., different from at least one other subset). For example, the measurement list may include/contain N (e.g., number of) DS-RTT/MS-RTT measurements. Each DS-RTT/MS-RTT measurement can include/consist of multiple measurement subsets. Each measurement subset can correspond to at least one Rx-Tx round-trip. Some features of FIG. 19 can be similar to or correspond to certain features of FIG. 20.

For example, referring to FIG. 19, the UE 104 can report measurement information (e.g., measurement results report or NR SL multi-RTT signal measurement information) to another UE 104 (1902). The measurement results report can include at least a measurement list (e.g., NR SL multi-RTT measurement list) (1904). In this case, the measurement list can include a number of DS-RTT/MS-RTT measurement pairs/groups (e.g., described in conjunction with the above-listing of the measurement list) (1906). In some cases, the measurements of one or more groups/pairs can share one or more common parameters (1908). The parameter(s) can include at least one of timestamp(s), SL-PRS information, among other aforementioned parameters (1910). In some other cases, the measurements of the groups/pairs may include or own dedicated/respective parameter(s) (e.g., not shared with at least one other measurement or at least one other group) (1912). The parameter(s) in this case can include at least one of SL-PRS information, RxTx time difference, timestamp(s), timing quality, TEG, path(s), additional measurement(s), among other aforementioned parameters (1914).

In another example, referring to FIG. 20, the UE 104 can report measurement information (2002) including at least one measurement list (2004), such as similar to ACT 1902 and ACT 1904. In this case, the measurement list can include a number of DS-RTT/MS-RTT measurements (2006), where each measurement may include at least one measurement subset. In some cases, the measurement subsets across of at least one measurement in the list can include common parameter(s) (2008). The parameter(s) can include at least one of timestamp(s), SL-PRS information, among other aforementioned parameters (2010). In some other cases, the measurement subsets of at least one measurement may include or own dedicated/respective parameter(s) (e.g., not shared with another subset(s)) (2012). The parameter(s) in this case can include at least one of SL-PRS information, RxTx time difference, timestamp(s), timing quality, TEG, path(s), additional measurement(s), among other aforementioned parameters (2014).

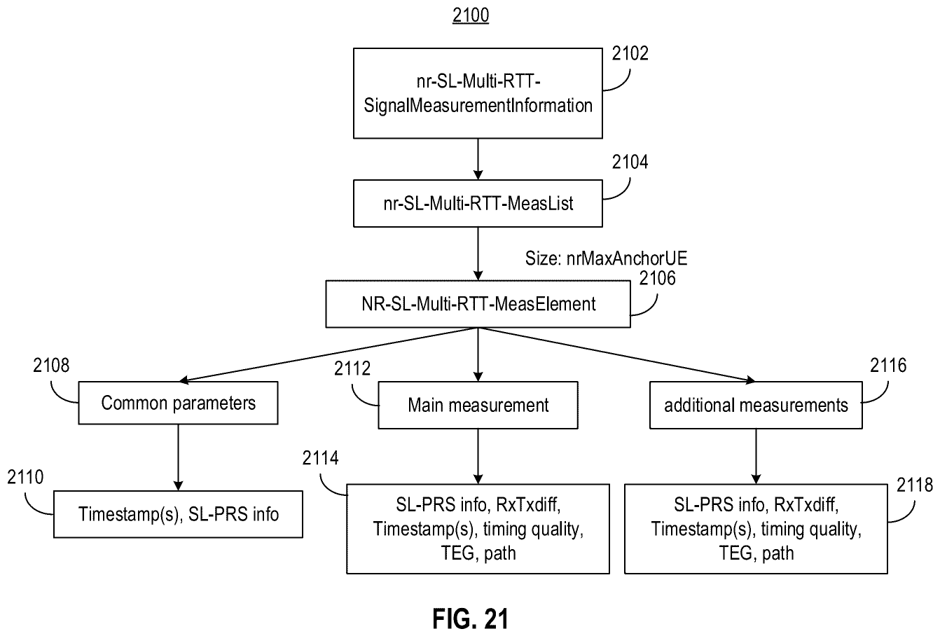

Referring to FIG. 21, depicted is a flow diagram 2100 of an example of using at least one additional measurement to contain/include/provide DS-RTT/MS-RTT measurements. One or more of ACTS 2102-2114 can include similar features/operations/details, such as described in conjunction with at least one of ACTS 1902-1914 and/or ACTS 2002-2014 (e.g., in conjunction with FIGS. 19-20). In this case, the measurement list may include one or more additional measurements (2116). The additional measurement(s) can include at least one of SL-PRS information, RxTx time difference, (e.g., measurement) timestamp(s), timing quality, TEG, path(s), among others described herein (2118).

In various implementations, SL DS-RTT/MS-RTT measurement timestamp can represent/define/indicate a time instance for which the SL-PRS measurement is performed or the time instance for which the SL-PRS measurement is performed compared with the reference timestamp. In some cases, the timestamp can be leveraged/used to indicate the time instance that the UE 104 transmits SL-PRS and/or receives SL-PRS. Similar to SL DS-RTT/MS-RTT Rx-Tx time difference, DS-RTT/MS-RTT measurement timestamp may be defined in at least two granularity levels, for example. The total timestamp can be equal to the sum of the high granularity level timestamp and low granularity level timestamp.

The SL DS-RTT/MS-RTT timestamp field may include at least one of the following information: DFN, slot number within the DFN, SFN, slot number within the SFN, the subframe number within a frame, slot number within a frame (e.g., may be related to SCS), symbol number within a slot, the particular/exact time location within a symbol (e.g., the timing resolution can be at least one of: nanosecond, multiple nanoseconds, T_{c}, multiple T_{c}, etc.), and/or current UTC time obtained from GNSS, among others. If the synchronization source is the BS 102, at least one of the following information can be added/provided in SL SS-RTT timestamp field: the ID of TRP (e.g., which the SFN is applicable for SL-PRS transmission), physical cell ID, global cell ID, ARFCN of the TRP, and/or timestamp ID, etc.

In some implementations, there may be some certain association relationships among the SL-PRS transmission configuration, timestamps, and/or UE Rx-Tx time difference for SL DS-RTT/MS-RTT. For example, the following can be considered/accounted for:
Timestamps can be consistent/in accordance with the SL-PRS transmission configuration. If the SL-PRS transmission time of the UE 104 (e.g., transmitter UE) is informed to receiver UE, the receiver UE can infer/determine/identify the expected receiving timestamp.
Two or more UE Rx-Tx time differences may share at least one common timestamp.
   The common timestamp can be the ending timestamp for the first/previous UE Rx-Tx time difference and/or the starting timestamp for the latter/next UE Rx-Tx time difference.
UE Rx-Tx time difference may be derived from multiple timestamps.
   The UE 104 may report several timestamps and/or several Rx-Tx time differences, such as to at least one other network node. The Rx-Tx time difference can be determined/obtained based on the difference (e.g., subtraction) of two consecutive timestamps.
The UE Rx-Tx time difference(s) for one DS-RTT/MS-RTT procedure may share at least one of the following parameters: same reference timing for timestamps, time mark, SL-PRS resources, TEG, path, etc.
For a DS-RTT/MS-RTT (e.g., procedure/process/operation), each UE 104 may report multiple timestamps and/or Rx-Tx time differences.
   One ID can be attached with each timestamp.
   One ID may be attached with each Rx-Tx time difference.
   Each Rx-Tx time difference may be associated with multiple timestamps.
   For one DS-RTT/MS-RTT, the first UE's timestamp #x (e.g., a certain time slot) can be the same as the second UE's timestamp #x at least at the slot level. The start and/or end time of the first UE's Rx-Tx time difference #x can be the same as the start and/or end time of the second UE's Rx-Tx time difference #x at least at the slot level.
The total number of timestamps and Rx-Tx time difference can be associated with or related to which type of DS-RTT/MS-RTT UE is utilized. For example:
   DS-RTT with four messages:
      Each UE 104 may report four timestamps and/or two UE Rx-Tx time differences.
      The first Rx-Tx time difference can be between the first two timestamps and the second Rx-Tx time difference can be between the third and fourth (e.g., last two) timestamps, or between other timestamps.
   DS-RTT with three messages and/or ADS-RTT with three messages:
      Each UE 104 may report three timestamps and two UE Rx-Tx time differences.
   MS-RTT:
      Each UE 104 may report multiple/numerous timestamps and multiple Rx-Tx time differences, based on the number of round trips or messages communicated between the network nodes.

### Processing Delay for DS-RTT/MS-RTT

In some arrangements, the time to completion for DS-RTT/MS-RTT positioning procedure can be reduced/minimized/controlled (e.g., control transmission times of DS-RTT/MS-RTT). For example, at least one (e.g., configured/preconfigured) measurement time window can be applied. The measurement time window may be configured through at least one of the following: configured by LMF via LPP, through UE-2-UE connection (e.g., PC5-RRC signaling, PC5-S signaling, application layer, a new layer dedicated for SL positioning, such as SL-LMF via SL-LPP, MAC CE, and/or physical layer signaling, such as SCI), according to the UE configuration, determined/selected/decided by the higher layer of the UE 104 (e.g., PC5-RRC layer, PC5-S layer, application layer, a new layer dedicated for SL positioning, such as SL-LMF), and/or according to the implementation/specification.

In some cases, the measurement time window can be used to restrict the time duration for at least one DS-RTT/MS-RTT procedure. The measurement time window may represent/be defined as/correspond to the maximum time duration/separation between the first timestamp and the last timestamp used in at least one SL DS-RTT/MS-RTT report, and/or the maximum number of the sum of the Rx-Tx time differences.

### SL Double-Sided Multi-RTT Error

In some implementations, if error(s) occur, the UE 104 may report a description or a reason for the error (e.g., error message) to the location server (e.g., LMF). The error can include at least one of the following: undefined, assistance data not supported, assistance data currently not available (e.g., although may be supported), on-demand SL-PRS not supported by the LMF, on-demand SL-PRS supported by LMF but not currently available, missing UE assistance data, unable to measure UE(s) 104, missing SL-PRS configuration, unable to transmit SL-PRS, conflict, which of the round trips failed, among other types of error indication.

In some cases, if the first round trip (or at least one other round trips) is successfully achieved/performed while at least one latter/subsequent round trip failed, a fallback mechanism from MS-RTT to DS-RTT and/or from DS-RTT to SS-RTT may be configured/structured/designed/provided to allow the UE 104 to report at least of the first and/or at least one other round trip measurements that are successfully performed instead of only reporting an error message. The feature/mechanism (e.g., fallback mechanism) can be up to or dependent on the configuration of the LMF, and/or each UE 104 may be preconfigured with this feature.

### Arrangement 5: Uu DS-RTT (e.g., BS 102 Rx-Tx Time Difference, Procedure)

In various arrangements, DS-RTT/MS-RTT (e.g., including DS-RTT with four messages, DS-RTT with three messages, ADS-RTT with three messages, MS-RTT, etc.) may be introduced or used to improve NR Uu RTT-based positioning accuracy. The LMF may use NRPPa signaling to inform the BS 102 which type of DS-RTT/MS-RTT to be utilized for positioning. In some cases, the BS 102 may request the LMF (e.g., via NRPPa) regarding the type of RTT to be utilized.

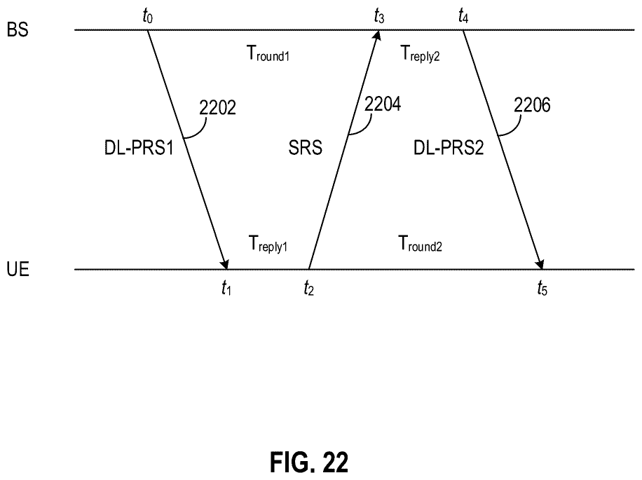

Referring to FIG. 22, depicted is an example 2200 of DS-RTT between the BS 102 and the UE 104. In various implementations, the BS 102 may communicate with the UE 104 through RRC, MAC CE, and/or DCI to request the capability of the UE 104 and/or send the RTT-based configuration to the UE 104. The UE 104 may report the preferred RTT type (e.g., as part of the UE capability) to the BS 102, such as in response to the request for the UE capability. According to or based on the preferred RTT type, the BS 102 and the UE 104 can initiate one or more round trips. For example, as shown in FIG. 22, the BS 102 can communicate DL-PRS 1 to the UE 104 to initiate a first round trip (2202). The UE 104 can reply to the BS 102 with SRS and/or initiate a second round trip with the SRS (2204). In response to the SRS, the BS 102 can transmit DL-PRS 2 to the UE 104 as part of the second round trip (2206), the DL-PRS 2 may or may not initiate a third round trip, etc., for example.

Control information used to indicate the configuration/triggering/activation/deactivation for the order of Tx-to-Rx round trip for DS-RTT can be configured/designed.
For example, the control information can be carried/contained in at least one of the higher layer signaling, the lower layer signaling, or the higher layer signaling and the lower layer signaling. In some cases, the control information can be carried/included in each DL-PRS and/or SRS for positioning transmission and/or used at the start of Tx-to-Rx round trip. The higher or lower signaling(s) can be at least one of the following:
   A higher layer signaling may be communicated from an LMF to a BS 102 via NRPPa.
   A higher layer signaling may be communicated from an LMF to a UE 104 via LPP.
   A higher layer signaling may be communicated from a BS 102 to a UE 104 via RRC.
   A higher layer signaling may be communicated from a UE 104 to another UE 104 via PC5-RRC signaling, PC5-S signaling, application layer, and/or a new layer dedicated for SL positioning, such as SL-LMF via SL-LPP.
   A lower layer signaling may be communicated from a BS 102 to a UE 104 via DCI and/or MAC CE. The UE 104 may indicate the control information in PUCCH.
   If both the higher layer signaling and lower layer signaling are involved in the configuration/triggering/activation/deactivation of DS-RTT/MS-RTT, a higher layer signaling may be used for DL-PRS/SRS configuration and/or coordinating the corresponding configuration/capabilities to the UE 104 and/or BS 102 in DS-RTT/MS-RTT, and/or a lower layer signaling may be used for initiating/activating/deactivating each Tx-to-Rx round trip.
The content of the control information used for Uu DS-RTT/MS-RTT can include at least one of the following:
   The first and/or second Tx-to-Rx round trip indicator.
      Using multiple bits.
      Control information may include the order of Tx-to-Rx round trip(s) (e.g., first, second, and/or third, etc. round trip(s)),
   Control information may represent whether the RTT measurements is used/configured for feedback.
   One ID for each DS-RTT/MS-RTT procedure. There may be multiple DS-RTT/MS-RTT measurements between the UE 104 and BS 102/TRP. The ID can be used to distinguish at least one certain DS-RTT/MS-RTT.

The BS/gNB/TRP Rx-Tx time difference for Uu DS-RTT can be defined as the difference between received timing and transmit timing. For example, the BS Rx-Tx time difference for SL DS-RTT can be defined in multiple granularity levels (e.g., high granularity level and/or low granularity level, etc.). The total DS-RTT Rx-Tx time difference can be determined as the sum of the high granularity level BS Rx-Tx time difference and low granularity level BS Rx-Tx time difference.

### High Granularity Level BS Rx-Tx Time Difference

High granularity level BS Rx-Tx time difference can be used to provide coarse-grained measurement results and/or rough/coarse propagation time (e.g., relatively coarser resolution). The resolution step of this coarse time difference can be at least one of the following: slot, the absolute time of a slot, millisecond, and/or subframe, etc. The reporting range of the high granularity level BS Rx-Tx time difference can be related to or associated with the total slot number (e.g., Nmax) and/or total time-domain resource (e.g., Tmax ms) of an SL-PRS resource pool/configuration. At least one of the following report timing strategies can be considered/utilized:
The reporting range for the high granularity level BS Rx-Tx time difference can be defined from −0.5*Nmax to 0.5*Nmax slot with the resolution step of one slot.
The reporting range for the high granularity level BS Rx-Tx time difference can be defined from −0.5*Tmax to 0.5*Tmax ms with the resolution step of one millisecond.

### Low Granularity Level BS Rx-Tx Time Difference

Low granularity level BS Rx-Tx time difference can be intended/used to provide finer-grained measurement results (e.g., relatively finer resolution). The reporting range of the finer-grained results can be related to the absolute time of a subframe (e.g., 1 ms) and/or a slot (e.g., 2^{-μ} ms). The resolution step of this finer time difference can be at least one of the following: nanosecond, multiple nanoseconds, T_{c}, multiple T_{c}, etc. Time units T_{c}=1/(Δfₘₐₓ·N_{f}) where Δfₘₐₓ=480·10³ Hz and N_{f}=4096. At least one of the following report timing strategies can be considered:
The reporting range for the lowgranularity level BS Rx-Tx time difference can be defined from −0.5 to 0.5 slot with the resolution step selected from one of the following: ns, 2^{k} ns, T_{c}, 2^{k}*T_{c}, etc.
The reporting range for the low granularity level gNB Rx-Tx time difference can be defined from −0.5 to 0.5 ms with the resolution step selected from one of the following: ns, 2^{k}*ns, T_{c}, 2^{k}*T_{c}, etc.

The ‘k’ can represent the timing reporting granularity factor for finer-grained Rx-Tx time difference. The BS-UE DS-RTT Rx-Tx time difference-related parameter(s) can include at least one of the following: reporting range for the high granularity level BS Rx-Tx time difference, resolution step for the high granularity level BS Rx-Tx time difference, reporting range for the low granularity level BS Rx-Tx time difference, resolution step for the low granularity level BS Rx-Tx time difference, k value, and/or reporting strateg(ies), among others. The configuration of the one or more parameters can include the following configurations/alternatives/options/implementations:
Configured or recommended by the LMF via NRPPa.
Up to the BS implementation for configuration of the one or more parameters.

In some implementations, if at least one parameter (e.g., timingReportinglowGranularityFactor) is used by the LMF to configure and/or recommend k for the BS 102, at least one of the following options/configurations can be applied by the BS 102:
k>=timingReportinglowGranularityFactor;
k>timingReportinglowGranularityFactor;
k=timingReportinglowGranularityFactor;
k<=timingReportinglowGranularityFactor; and/or
k<timingReportinglowGranularityFactor.

In certain aspects, the communication/indication of the preferred reply time(s) to be used by the UE 104 and the BS 102/TRP can be provided before the DS-RTT/MS-RTT procedure. The information may contain at least one of the following: UE preferred reply times (e.g., multiple potential reply time(s), the reply time(s) of one or more UEs 104 may or may not be the same with at least one other UEs 104), BS 102/TRP preferred reply time(s) (e.g., multiple potential reply times, which may or may not be the same between one or more UEs 104 and/or other BS 102).

The preferred reply time exchange between the UE 104 and the BS 102 may be triggered by at least one of the UE 104 and/or another network node (e.g., BS 102 and/or LMF). If the preferred reply time exchange between UE 104 and BS 102 is triggered by an LMF, the triggered signaling may be at least one of LPP and/or NRPPa. In some cases, the BS 102 may use at least one of DCI and/or MAC CE to trigger the preferred reply time exchange between UEs 104 and/or between the UE 104 and the BS 102.

From BS/gNB side, the BS 102 can configure SRS resources(s) for positioning without requiring the UE 104 to provide the reply preferred time, for example. The preferred reply time(s) of the UE 104 and BS 102 may be transmitted from the network (e.g., BS 102 and/or LMF) to the UE 104. The LPP signaling can be used if the LMF provides the information to the UE 104. At least one of the RRC and/or DCI signaling can be used if the BS 102 provides the information to the UE 104. In some implementations, the preferred reply time(s) may be (e.g., first) transmitted/provided from the BS 102 to the LMF via NRPPa signaling, and subsequent, the LMF can provide the information to one or more UEs 104. In some cases, the preferred reply time(s) may be transferred along with assistance data or as a part of the assistance data.

### Processing Sample(s)

In some implementations, the UE 104 may report its capability regarding the minimum/maximum number of DL-PRS processing samples (e.g., UE Rx-Tx time difference measurement samples) to the LMF and/or the BS 102, and/or one or more other UEs 104 (e.g., through higher layer from at least one of: MAC CE, PC5-RRC, PC5-S, a new higher layer dedicated for SL positioning, such as SL-LMF, and/or application layer, etc.) may request the number of SL-PRS processing samples (e.g., UE Rx-Tx time difference measurement samples) from the UE 104. In some cases, the BS 102 may report its supported number of processing samples to the LMF and/or the UE 104. The LMF can send the configuration regarding the sample number to the BS 102 via NRPPa and/or to the UE 104 via LPP.

In various implementations, the measurement report may indicate the sample ID. The sample ID may be included as a part of DS-RTT/MS-RTT ID. For one or more of the multiple Rx-Tx measurement reports of the UE 104 in DS-RTT/MS-RTT, the measurement reports may share the same sample ID with each other, in some cases. For one or more of the multiple Rx-Tx measurement reports of the BS 102/TRP in DS-RTT/MS-RTT, the measurement reports may share the same sample ID with each other, for example.

If a UE 104 and a BS 102/TRP (e.g., involved in the same DS-RTT/MS-RTT procedure) include or are associated with the same number of processing samples, they may share the same sample ID in the measurement report. In some other cases, the number of processing samples for a UE 104 and a BS 102/TRP (e.g., involved in the same DS-RTT/MS-RTT procedure) may be different, such that the ID in the measurement report may be different between the UE 104 and the BS 102/TPR. In various implementations, the UE 104 and/or BS 102 may perform multiple measurements (e.g., to obtain multiple samples) for one measurement report. For example, if the UE 104 obtains/has three samples (e.g., sample #1, sample #2, and sample #3) for one measurement report, and the BS 102 obtains/has the same number of samples (e.g., sample #1, sample #2, sample #3) for one measurement report, the sample ID for the UE 104 and the BS 102 can match (e.g., UE sample #1+BS sample #1). If UE sample #1+BS sample #1 is chosen/selected, the timestamp, Rx-Tx time difference, etc., can be a part of the measurement results for measurement sample #1, such as sample #1 of both UE 104 and the BS 102.

In various aspects, the Uu DS-RTT and/or MS-RTT, the UE measurement results report can be at least one of the following:
DS-RTT and/or MS-RTT ID shared by the UE 104 and/or BS 102/TRP. In some cases, there may be multiple DS-RTT measurements between the UE 104 and the BS 102/TRP, and the (e.g., DS-RTT and/or MS-RTT) ID can be shared by both the UE 104 and BS 102/TRP involved in the same DS-RTT procedure.
Sample ID.
A measurement list:
   The measurement list can include/contain N (e.g., N number of) DS-RTT/MS-RTT measurement pairs/groups. Each DS-RTT/MS-RTT measurement pair/group can include multiple measurement elements. In this case, each measurement element corresponds to one Rx-Tx round-trip.
   The measurement list may contain N DS-RTT/MS-RTT measurements. Each DS-RTT/MS-RTT measurement can include multiple measurement subsets. In this case, each measurement subset corresponds to one Rx-Tx round-trip.
   The measurement list may contain N DS-RTT/MS-RTT measurements. Each DS-RTT/MS-RTT measurement can include multiple Rx-Tx time differences and/or some other measurements, which can be presented as part of the additional measurements.
   For at least one UE measurement report, N can be the total/maximum number of anchor/assisting/neighbor/peer UEs for DS-RTT/MS-RTT.
Pair/group ID, measurement subset ID, and/or other ID to uniquely identify whether the measurements of at least one UE 104 is configured be packed/grouped together for DS-RTT/MS-RTT.
   The ID can be 1 bit to indicate whether the one or more measurements are part of a group.
   The maximum number of bits for the ID can be configured by the LMF and/or by the higher layer of the UE 104 (e.g., at least one of: PC5-RRC, PC5-S, application layer, and/or SL-LMF via SL-LPP signaling, among others). The ID can be used to indicate which group/pair/subset the measurement(s) belong to.
TRP ID and/or BS 102/gNB information.
TA offset used by the UE 104.
SRS-TxTEG. The SL-PRS resources associated with a particular UE Tx TEG may contain at least one timestamp to specify the end time and/or start time of the SRSTxTEG element and/or the ID of the UE Tx TEG.
DL-PRS resource information. The DL-PRS resource set ID and/or DL-PRS resource ID may be an ID to uniquely identify a DL-PRS resource associated with a single TRP.
Cell information, physical cell ID, global cell ID, and/or ARFCN.
The UE Rx-Tx time difference measurement, such as including at least one of high granularity and/or low granularity measurement(s).
Additional path timing value.
Additional path list.
Timestamp, the description/detail of which can be provided herein.
Timestamp shared by the measurement group/element/subset. This timestamp can be defined or referred to as a reference timestamp and/or the start time of the DS-RTT/MS-RTT procedure.
Timing quality, such as the determination/estimation by the UE 104 of the quality of the measurement.
DL-PRS RSRP result.
TEG information, e.g., one or more of the following: UE RxTx TEG ID, UE Tx TEG ID, and/or UE Rx TEG ID, etc.
DL-PRS RSRPP.
LOS/NLOS indicator.
Additional measurements:
   Up to a maximum number of additional measurements.
   For each additional measurement, at least one of the following can be included: cell information, DL-PRS resource information, additional DL-PRS RSRP, additional DL-PRS RSRPP, additional UE Rx-Tx time difference, timestamp, timing quality, TEG information, the association of TEG and SRS resource, the association of TEG and measurements, etc.
   The additional UE Rx-Tx time difference in the additional measurements may be the absolute value or a result relative to the aforementioned UE Rx-Tx time difference.
   The additional DL-PRS RSRP may be the absolute value or a result relative to DL-PRS RSRP, such as described above.
   The additional DL-PRS RSRPP may be the absolute value or a result relative to DL-PRS RSRPP, such as described above.

For Uu DS-RTT and/or MS-RTT, the measurement results report of the BS 102/TRP can include, correspond to, or be at least one of the following:
DS-RTT and/or MS-RTT ID shared by the UE 104 and/or BS 102/TRP. There may be multiple DS-RTT measurements between the UE 104 and BS 102/TRP, which this (e.g., DS-RTT and/or MS-RTT) ID can be shared by both of the UE 104 and BS 102/TRP involved in one DS-RTT procedure.
Sample ID.
A measurement list.
   The measurement list may contain N DS-RTT/MS-RTT measurement pairs/groups. Each DS-RTT/MS-RTT measurement pair/group can include multiple measurement elements. In this case, each measurement element can correspond to one Rx-Tx round-trip.
   The measurement list may contain N DS-RTT/MS-RTT measurements. Each DS-RTT/MS-RTT measurement can include multiple measurement subsets. In this case, each measurement subset can correspond to one Rx-Tx round-trip.
   The measurement list may contain N DS-RTT/MS-RTT measurements. Each DS-RTT/MS-RTT measurement can include multiple Rx-Tx time differences and/or some other measurements which can be presented in the additional measurements.
   For at least one BS 102/TRP measurement report, N can correspond to or refer to the total/maximum number of anchor/assisting/neighbor/peer UEs for DS-RTT/MS-RTT.
Pair/group ID, measurement subset ID, and/or other IDs to uniquely identify whether the measurements of at least one UE 104 is configured to be packed/grouped together for DS-RTT/MS-RTT.
   The ID can be 1 bit to indicate whether the one or more measurements are part of a group.
   The maximum number of bits for the ID can be configured by the LMF and/or according to the implementation/configuration of the BS 102.
UE ID. The BS 102 can report the ID information of the UE it interacts/communicates with in an RTT procedure.
DL-PRS-TxTEG. The DL-PRS resources associated with a particular gNB/TRP Tx TEG may contain at least one timestamp to specify the end time and/or start time of DL-PRS-TxTEG element. The gNB/TRP Tx TEG can be identified by an associated ID.
DL-PRS resource information including at least one of: resource ID, and/or resource set ID, etc.
SRS for positioning resource information, such as at least one of resource ID, resource set ID, etc.
Cell information, physical cell ID, global cell ID, and/or ARFCN.
BS Rx-Tx time difference measurement.
Additional path timing value.
Additional path list.
Timestamp, the definition or description of which can be described herein.
Timestamp shared by the measurement group/element/subset. This timestamp can be defined as a reference timestamp and/or the start time of the DS-RTT/MS-RTT procedure.
Timing quality, such as an estimation or determination of the quality of the measurement by at least one of the network nodes (e.g., the UE 104, BS 102, and/or LMF).
UL SRS RSRP result.
TEG information, such as one or more of the following: UE RxTx TEG ID, UE Tx TEG ID, and/or UE Rx TEG ID.
UL SRS RSRPP.
LOS/NLOS indicator,
UL Angle of Arrival (e.g., azimuth and/or elevation).
Beam Information of the measurement.
Additional measurements.
   Up to a maximum number of additional measurements.
   For each additional measurement, at least one of the following can be included: cell information, DL-PRS resource information, UL SRS for positioning resource information, additional SRS RSRP, additional SRS RSRPP, additional BS 102/TRP Rx-Tx time difference, timestamp, timing quality, TEG information, the association between TEG and DL-PRS resource, the association between TEG and UL SRS-related measurements, UL Angle of Arrival (e.g., azimuth and elevation), and/or beam information of the measurement, among others.
   Additional gNB/TRP Rx-Tx time difference in the additional measurements may be the absolute value and/or a result relative to UE Rx-Tx time difference, such as described above.
   Additional SRS RSRP may be the absolute value and/or a result relative to SL-PRS RSRP, such as described above.
   Additional SRS RSRPP may be the absolute value or a result relative to SL-PRS RSRPP, such as described above.

For Uu DS-RTT/MS-RTT measurement timestamp for UE 104:
For Uu DS-RTT/MS-RTT measurement report of the UE 104, the timestamp can represent or indicate a time instance for which the measurement is performed. In some cases, the timestamp can indicate the time instance for which measurement is performed compared with the reference timestamp. The timestamp may be used to indicate the time instance for which the UE 104 transmits/sends SRS and/or receives DL-PRS. Similar to the Uu DS-RTT/MS-RTT Rx-Tx time difference, the DS-RTT/MS-RTT measurement timestamp may be defined in two granularity levels (e.g., higher granularity level and/or lower granularity level). The total timestamp can be the sum of the high granularity level timestamp and low granularity level timestamp.
The Uu DS-RTT/MS-RTT UE timestamp field may include at least one of the following information: DFN, slot number within the DFN, SFN, slot number within the SFN, the subframe number within a frame, slot number within a frame (e.g., related to SCS), symbol number within a slot, the exact time location within a symbol (e.g., the exact timing resolution can be at least one of: nanosecond, nanoseconds, T_{c}, and/or multiple T_{c}, etc.), current UTC time obtained from GNSS and/or BS 102, the ID of TRP which the SFN may be applicable for DL-PRS transmission, physical cell ID, global cell ID, ARFCN of the TRP, timestamp ID, and/or DL-PRS ID, etc.

For Uu DS-RTT/MS-RTT measurement timestamp for BS 102/TRP:
For Uu DS-RTT/MS-RTT measurement report of the BS 102/TRP, the timestamp can indicate a time instance for which the measurement is performed. In some cases, the timestamp can indicate a time instance for which measurement is performed compared with the reference timestamp. The timestamp may be used to indicate the time instance for which BS 102/TRP transmits DL-PRS and/or receives SRS. DS-RTT/MS-RTT measurement timestamp of BS 102/TRP may be defined in two granularity levels. The total timestamp can equal or be the sum of the high granularity level timestamp and low granularity level timestamp.
The Uu DS-RTT/MS-RTT BS/TRP timestamp field may include at least one of the following information: DFN, slot number within the DFN, SFN, slot number within the SFN, the subframe number within a frame, slot number within a frame (e.g., related to SCS), symbol number within a slot, the exact time location within a symbol (e.g., the exact timing resolution can be at least one of: nanosecond, nanoseconds, T_{c}, multiple T_{c}, etc.), current UTC time obtained from GNSS, the ID of TRP, physical cell ID, global cell ID, ARFCN of the TRP, timestamp ID, and/or measurement time, etc.

In some implementations, there may be certain associated relationships among the DL-PRS transmission configuration, UL SRS for positioning transmission configuration, timestamp(s) of the UE 104, timestamp(s) of the BS 102/TRP, UE Rx-Tx time difference, and/or BS 102/TRP Rx-Tx time difference for SL DS-RTT/MS-RTT, for example. In this case, at least one of the following can be considered:
The UE timestamps and BS 102/TRP timestamps can be consistent with DL-PRS transmission configuration and UL SRS for positioning transmission configuration.
Multiple UE Rx-Tx time differences may share at least one common timestamp.
   The common timestamp can be the ending timestamp for the first/previous UE Rx-Tx time difference and/or the starting timestamp for the latter/next UE Rx-Tx time difference.
Multiple BS 102/TRP Rx-Tx time differences may share at least one common timestamp.
   The common timestamp can be the ending timestamp for the first/previous BS 102/TRP Rx-Tx time difference and/or the starting timestamp for the latter/next BS 102/TRP Rx-Tx time difference.
The UE 104 and BS 102/TRP Rx-Tx time difference may be derived from at least two timestamps.
   For instance, the time difference can be determined/obtained by subtracting two consecutive timestamps of the UE 104 and BS 102.
Different UE Rx-Tx time differences for one DS-RTT/MS-RTT procedure may share at least one of the following parameters: same reference timing for timestamps, time mark, DL-PRS resources, SRS resources, TEG, and/or path, among others.
Different BS Rx-Tx time differences for one DS-RTT/MS-RTT procedure may share at least one of the following parameters: same reference timing for timestamps, time mark, DL-PRS resources, SRS resources, TEG, and/or path, etc.
For a DS-RTT/MS-RTT, UE 104 and BS 102/TRP may report multiple timestamps and Rx-Tx time differences.
   One ID can be attached/associated with each timestamp.
   One ID may be attached with each Rx-Tx time difference.
   Each Rx-Tx time difference may be associated with multiple timestamps.
   For one DS-RTT/MS-RTT, the UE timestamp #x can be the same as BS 102/TRP timestamp #x at least at/in slot level. The start and/or end time of UE Rx-Tx time difference #x can be the same as the start and/or end time of BS 102/TRP Rx-Tx time difference #x at least at slot level.
The total number of timestamps and/or Rx-Tx time difference can be related to which type of DS-RTT/MS-RTT is used.
   For DS-RTT with four messages:
      A UE may report four timestamps and two UE Rx-Tx time differences.
      A BS 102/TRP may report four timestamps and two UE Rx-Tx time differences.
   For DS-RTT with three messages and/or ADS-RTT with three messages:
      A UE may report three timestamps and two UE Rx-Tx time difference.
      A BS 102/TRP may report three timestamps and two UE Rx-Tx time differences.
   For MS-RTT:
      Each UE and/or each BS 102/TRP may report multiple timestamps and multiple Rx-Tx time differences.

### Processing Delay for DS-RTT/MS-RTT

To reduce and control transmission times of Uu DS-RTT/MS-RTT, a (e.g., configured or preconfigured) measurement time window can be applied. The measurement time window may be configured through at least one of the following:
Configured by LMF via LPP (e.g., for UE 104) and/or NRPPa (e.g., for BS 102).
Configured by the BS 102. The BS 102 can transmit the measurement window configuration to the UE 104 via at least one of RRC, DCI, and/or MAC. In some cases, the BS 102 may (e.g., first or initially) send the measurement window configuration to the LMF via NRPPa. Subsequently, the LMF can inform/transmit the measurement window configuration to the UE 104 via LPP,
In some cases, the measurement time window can be configured according to the UE capability/configuration/setting.

The measurement time window can be used to restrict the time duration for a DS-RTT/MS-RTT procedure. The measurement time window can be defined as the maximum time duration/separation between the first timestamp and the last timestamp used in one SL DS-RTT/MS-RTT report, and/or the maximum number of the sum of all the Rx-Tx time differences of a UE and/or the maximum number of the sum of all the Rx-Tx time differences of a BS 102.

### Measurement Error for Uu DS-RTT/MS-RTT

In various arrangements, if errors occur, the UE may report the error reason/explanation/description to the location server (e.g., LMF). In some cases, if errors occur, the BS 102/TRP may report the error reason to the location server (e.g., LMF). The error can include or correspond to at least one of the following: undefined, assistance data not supported, assistance data supported but currently unavailable, on-demand DL-PRS not supported by the LMF, on-demand DL-PRS supported by the LMF but currently unavailable, missing UE assistance data, unable to measure UE positioning, missing UL-SRS configuration, unable to transmit UL-SRS, conflict, and/or which round trip failed, among other types of error messages.

In some implementations, if at least one round trip (e.g., first round trip) is successfully achieved but one or more other latter round trips failed, a fallback mechanism/technique/feature from MS-RTT to DS-RTT and/or from DS-RTT to SS-RTT may be applied/designed/configured to enable the UE 104 and/or BS 102/TRP to report at least one successful round trip measurements (e.g., first one or more round trip measurements) instead of only report error message. The fallback feature can be up to the configuration of the LMF and/or each UE 104 and/or each BS 102/TRP.

### Hybrid Positioning (Joint SL and Uu Positioning)

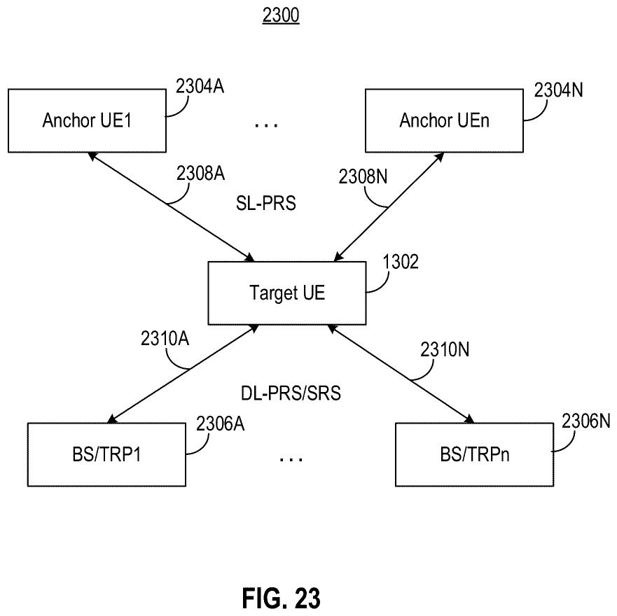

Referring to FIG. 23, depicted is an example 2300 of different RTTs supported by hybrid positioning. Considering in-coverage and/or partial-coverage scenarios, the network can be involved in SL-PRS configuration and/or assistance data transmission and/or position calculation/determination, etc. For example, hybrid multi-RTT positioning can be as follows: one or more of the UE(s) 104 (e.g., anchor UE(s) 2304A-N and/or target UE 2302) can perform SL measurement(s) and/or Uu positioning measurements (2308A-N), one or more BS 102/TRP(s) (e.g., gNB/TRP 2306A-N) can perform Uu positioning measurement(s) (2310A-N), and/or UE position/ranging can be estimated/determined using the one or more measurements derived/obtained on at least one of or both SL and/or Uu positioning.

In some implementations, hybrid positioning can support various types of RTT (e.g., SS-RTT and/or DS-RTT/MS-RTT). The UE may report whether it supports and/or prefers hybrid RTT positioning. The LMF can be used to schedule the UE 104 and/or BS 102 and/or calculate/determine the target UE position/location. The assistance data sent from the LMF to the UE 104 may include, such as in addition to the DL-PRS-related information, SL-PRS-related information. The LMF may request the UE 104 for at least one of SL positioning measurements and/or Uu positioning measurements. The LMF may request the BS 102 for Uu positioning measurements, for example.

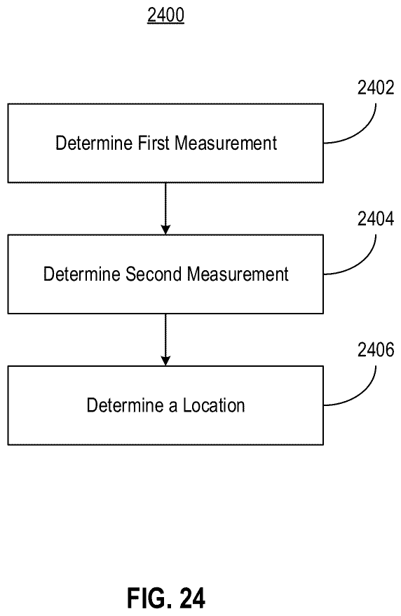

FIG. 24, is a flow diagram illustrating an example method 2400 for RTT-based positioning. Referring to FIG. 24, the method 2400 can be performed by one or more network nodes (e.g., at least one BS 102/TRP, at least one UE 104, and/or at least one LMF). In some arrangements, at 2402, at least one network node can determine first measurement. At 2404, at least one network node can determine second measurement. At 2406, at least one network node (or other network nodes) determines the location of at least one of the network nodes.

Still referring to FIG. 24, and in further details, at 2402, a first network node can communicate (e.g., exchange information) with a second network node to determine first measurement. The first network node and/or the second network node can include, correspond to, or be one of a respective UE (e.g., wireless communication device), BS (e.g., wireless communication node), TRP, LMF, or other network entities, as discussed herein. In this case, the first and second network nodes can correspond to a respective UEs, such as a first UE (e.g., UE 1) and a second UE (e.g., UE 2). In some implementations, the first network node can correspond to a target UE and the second network node can correspond to one of one or more anchor UEs, or vice versa. In various arrangements, the first measurement can correspond to or be associated with a first round trip (e.g., including T_{round1} and/or T_{reply1}) of various round trips in an RTT procedure, for example.

At 2404, the first network node can communicate with the second network node to determine second measurement. The second measurement can correspond to a second round trip (e.g., including T_{round2} and/or T_{reply2}, in some examples). Using at least one or both of the first measurement and the second measurement, at least one network node and/or at least one network entity can determine the position/location of at least one of the network nodes (e.g., the first network node and/or the second network node), as discussed herein. In some cases, the measurement report can be performed for each network node. For instance, the first network node may report both T_{round1} and T_{reply2}, and/or the second network node may report both T_{reply1} and T_{round2}.

In various arrangements, DS-RTT procedure with four messages including two different initiators can be utilized/performed. For example, to determine the first measurement by communicating between the first network node and the second network node, the first network node (e.g., first UE) can send/transmit/provide/transfer/signal a first message (e.g., SL-PRS 1) to the second network node. In some implementations, the one or more messages discussed herein can correspond to or include at least one of SL-PRS, DL-PRS, and/or SRS, among others. Subsequent to transmitting the first message, the first network node can receive/obtain/acquire a first response/reply (e.g., SL-PRS 2) to the first message from the second network node. Further, to determine the second measurement, the first network node can receive a second message (e.g., SL-PRS 3) from the network node. Subsequently, the first network node can send a second response (e.g., SL-PRS 4 responsive to the second message) to the second network node. In this case, the first message and the second message can initiate the respective round trips, such as initiated by the first network node for the first round trip and the second network node for the second round trip.

In some arrangements, DS-RTT procedure with four messages having two identical initiators can be performed/executed. For example, to determine the first measurement, the first network node can send a first message (e.g., SL-PRS 1) to the second network node. The first network node can receive a first response/reply/answer (e.g., SL-PRS 2) from the second network node, such as in response to the first message. To determine the second measurement, the first network node can send a second message (e.g., SL-PRS 3) to the second network node. Similarly, the first network node can receive a second response (e.g., SL-PRS 4) from the second network node in response to the second message. In this case, the first message and the second message can initiate the respective round trips, where the initiator is the first network node.

In certain arrangements, ADS-RTT procedure with three messages can be performed. For example, to determine the first measurement, the first network node can send a first message (e.g., SL-PRS 1) to the second network node, thereby initiating a first round trip. In response to the first message, the first network node can receive a first response (e.g., SL-PRS 2) from the second network node. In this case, the first response can be used to initiate a second round trip. Accordingly, to determine the second measurement corresponding to the second round trip, the first network node can send a second message (e.g., SL-PRS 3) to the second network node in response to receiving the first response which initiated the second round trip.

In some implementations, the second message sent by the first network node can be sent at a time (e.g., the same or around the same time) when the first network node receive the first response from the second network node. In this case, the first network node can instantly reply to the second network node without waiting for the response message (e.g., SL-PRS 2). For instance, the first network node can be configured to expect or anticipate at least one response from at least the second network node (or other network nodes/entities) at a certain time. Hence, the first network node can transmit the second message at or around the same time as when the first network node receives a response to the first message.

In some implementations, MS-RTT procedure can be performed, which can be an extension of at least one of the DS-RTT procedures. For instance, subsequent to the first network node transmitting the second message in the second round trip, the first network node can receive a third message (e.g., SL-PRS 4, sometimes referred to as a second response) from the second network node in response to the second message. In this case, the second message and the third message can correspond to or be a part of a third round trip. Hence, the first network node and the second network node can communicate to determine a third measurement corresponding to the third round trip. The MS-RTT procedure can include an additional number of Tx-to-Rx round trips, such as more than three round trips, as described in this case.

In various aspects, each of the first measurement and/or the second measurement can include at least one of a reception-to-transmission (Rx-Tx) time difference as a time difference between an SL-PRS receiving time and/or an SL-PRS transmitting time. For example, a total Rx-Tx time difference for at least one of the first measurement and/or the second measurement can be determined based on a sum of a first Rx-Tx time having a higher granularity (e.g., higher granularity level) and/or a second Rx-Tx time having a lower granularity (e.g., lower granularity level). The higher granularity can be defined/represented/indicated by a coarser resolution step and/or a first reporting range (e.g., reporting range for high granularity level). The lower granularity can be defined by a finer resolution step based on a granularity factor and/or a second reporting range (e.g., reporting range for the low granularity level). In certain implementations, a reception-to-transmission (Rx-Tx) time difference may be determined based on one or more transmission characteristics (e.g., SL-PRS transmission slot time/slot index/timing, etc.) of the first network node and/or the second network node.

In some arrangements, the first network node can communicate with the second network node to provide preferred reply time(s) that can be applied by the first network node and/or the second network node. The preferred reply time can be applied before/prior to the communication between the first and second network nodes to determine the first measurement and/or the second measurement. The preferred reply time(s) can indicate when the first network node and/or the second network node can expect a response/reply from one another (among other network nodes).

In some implementations, the first network node can send measurement results report, such as to at least one network entity (e.g., BS/gNB/TRP/wireless communication node and/or LMF). The measurement results report can include at least one of: the first measurement and/or the second measurement (e.g., one or more Rx-Tx time differences and/or measurement list, etc.), an ID shared by the first network node and the second network node, a measurement timestamp (e.g., relative or not relative to reference timestamp) defining/indicating at least a time instance at which/when the first measurement and/or the second measurement is determined, and/or an ID (e.g., pair/group ID, measurement subset ID, and/or other IDs) indicating at least one group/pair of associated measurements, among others. In some cases, if MS-RTT is applied/performed, each network node may be configured to report multiple measurements to the network entity.

In various arrangements, for processing delay for DS-RTT/MS-RTT, at least one of the first measurement (e.g., Rx-Tx time difference), the second measurement (e.g., Rx-Tx time difference), transmission configuration(s) of signals (e.g., SL-PRS transmission configuration) used in determining the first measurement and/or the second measurement, and/or the measurement timestamp may be associated with one another. In certain instances, a measurement time window can be determined within which communicating to determine the first measurement and communicating to determine the second measurement are performed.

In some implementations, the first network node can receive at least one of assistance data, capability request, and/or measurement result request from the LMF (e.g., for LMF-based positioning). In some cases, at least one of: the assistance data can include/comprise transmission parameters, information related to a positioning method, quality of service (QoS) requirement of SL-PRS to be transmitted by the first network node; the measurement results request can include a request (e.g., such as described in the list of measurement results request) for the first network node to provide information related to SL-PRS transmitted by the first network node; and/or the capability request can include at least one of a request for the first network node to provide information related to whether a multi-RTT is supported by the first network node and/or a request for the first network node to enable multi-RTT functionalities.

In certain implementations, the first network node (and/or the second network node, among other network nodes) can send certain (e.g., suitable) information to the LMF. The information to send to the LMF can include at least one of capability report, assistance data request, and/or measurement results report. In some cases, at least one of: the assistance data request can include/comprise a request for transmission parameters of SL-PRS to be transmitted by the first network node; the measurement results report can include at least one of the first measurement and/or the second measurement, and/or each of the first measurement and/or the second measurement can include at least one of signal strength (e.g., RSRP), single-sided RTT (e.g., SS-RTT) reception-to-transmission time difference, and/or SS-RTT measurement time stamp; and/or the capability report can include information related to whether a single-sided multi-RTT may be supported by the first network node and/or the multi-RTT functionalities of the first network node (or the second network node, etc.), among others.

In some arrangements, a base station (e.g., BS/gNB) can transmit/send/provide at least one of assistance data and/or SL-PRS configuration data to an LMF. In certain arrangements, the LMF may send information (e.g., that may be transferrable to the BS/gNB) to a base station. For instance, the information can include at least one of SL-PRS transmission characteristic information, among others. In some cases, the first (e.g., target) network node (and/or the second network node or other network nodes) can send a capability report to the BS, LMF, and/or other network nodes. The capability report can include at least one of an indication of whether double-sided multi-RTT and/or multiple-sided multi-RTT is/are supported and/or an indication of a type of multi-RTT supported. The type of multi-RTT supported can include at least one of DS-RTT with four messages, DS-RTT with three messages, ADS-RTT with three messages, and/or MS-RTT with multiple-sided RTTs. For example, the first network node (e.g., a target UE) can communicate with one or more other network nodes (e.g., multiple anchor UEs). Each target and anchor UE pair (e.g., first and second network nodes) can conduct one RTT procedure, such as single-sided, double-sided, multiple-sided, etc., which respectively describes the number of round trip times/iterations. Hence, the single-sided, double-sided, and/or multiple-sided can correspond to a respective single-sided multi-RTT, double-sided multi-RTT, and/or multiple-sided multi-RTT.

In various aspects, the first network node can receive control information (e.g., from the second network node or other network node(s)). The control information can include at least one of: configurations for determining at least one of the first round trip and/or the second round trip; triggers for determining at least one of the first round trip and/or the second round trip; activating at least one of determining the first round trip and/or determining the second round trip; and/or deactivating at least one of determining the first round trip and/or determining the second round trip. In some cases, the control information can include at least one of: an indication of at least one of determining the first measurement and/or determining the second measurement; whether the first measurement and/or the second measurement is needed/required/configured for feedback; and/or an ID for at least one of or both of the first measurement and/or the second measurement. For instance, each network node can report the first measurement and/or the second measurement, among other measurements, for one DS-RTT procedure. In this case, the first and the second measurements can share the same ID. In some other cases, the first and second measurements can be associated with different IDs.

At 2406, a first location of the first network node and/or a second location of the second network node can be determined based at least in part on the first measurement and the second measurement. In some cases, the location can be determined based on measurements (e.g., including at least one or both of the first and second measurements, among other measurements) between the first network node (e.g., target UE) and one or more other network nodes (e.g., one or more anchor UEs).

In some arrangements, the network node(s) (e.g., first and/or second network nodes) can transmit/send the first measurement and/or the second measurement to an LMF (e.g., LMF-based positioning). The LMF can determine, based on at least one of the first measurement and/or the second measurement, the first location of the first network node and/or the second location of the second network node, such as according to the configuration/implementation of the LMF. In some implementations, at least one of the first network node and/or the second network node can determine, based on at least one of the first measurement and/or the second measurement, the first location of the first network node and/or the second location of the second network node.

In certain implementations, the first network node can be a wireless communication device (e.g., UE) and the second network node can be a base station (e.g., network entity). In this case, the first network node can receive control information. The control information can include at least one of: configurations for determining an order/sequence of the first round trip and the second round trip; triggers for determining the order of the first round trip and the second round trip; activating the order of the first round trip and the second round trip; and/or deactivating the order of the first round trip and the second round trip.

In some cases, the first network node can be a wireless communication device and the second network node can be a base station. In this case, the first network node can receive the control information. The control information can include at least one of: indication of an order for determining the first measurement or determining the second measurement; whether the first measurement or the second measurement is needed for feedback; and/or an ID for a procedure determining at least one of the first measurement or the second measurement.

In some embodiments, the first network node can be a wireless communication device and the second network node can be a base station. Each of the first measurement and/or the second measurement can include or be associated with a reception-to-transmission (Rx-Tx) time difference as a time difference between a signal receiving time and a signal transmitting time. In this case, a total reception-to-transmission (Rx-Tx) time difference can be determined (e.g., by the first and/or second network nodes) for each of the first measurement and/or the second measurement based on a sum of a first reception-to-transmission (Rx-Tx) time having a higher granularity and a second reception-to-transmission (Rx-Tx) time having a lower granularity, for example.

In various arrangements, a hybrid positioning (e.g., joint SL and Uu positioning) procedure can be deployed/performed/utilized. In this case, the first network node can communicate with a third network node to determine third measurement. For instance, the first network node (e.g., target UE) can communicate with both the second network node (e.g., at least one of the anchor UE) and the third network node (e.g., BS) to determine the first, second, and third measurements. The third measurement can correspond to a third round trip. In some cases, the first network node can communicate with the third network node to determine fourth measurement corresponding to a fourth round trip. The first network node can communicate with other network nodes to determine any additional measurement(s) corresponding to respective round trip(s). The first location of the first network node can be at least in part determined based on the first measurement, the second measurement, the third measurement, and/or the fourth measurement (e.g., can include additional measurements, such as estimated/determined based on several anchors or several BS/TRPs).

In various aspects described herein, a network entity (e.g., at least one of BS/gNB/TRP, LMF, etc.) can determine a first measurement corresponding to a first round trip of communications between a first network node (e.g., a first UE/wireless communication device or UE 1) and a second network node (e.g., a second UE/wireless communication device or UE 2). The network entity can determine second measurement corresponding to a second round trip of communications between the first network node and the second network node. The network entity can determine a first location of the first network node and/or a second location of the second network node at least in part based on the first measurement and the second measurement. In various arrangements, the network entity can be or refer to LMF, BS, or a UE (e.g., UE 1 or UE 2). The determination of certain information (e.g., measurement and/or location) may refer to or correspond to receiving of such information, for instance, if the network entity is one of LMF, BS, or a different UE (e.g., UE 2 different from UE 1 or UE 1 different from UE 2). In some cases, if the network entity is UE 1 or UE 2, the determination can correspond to or refer to calculation/computation for the aforementioned information, for example.

While various arrangements of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of some arrangements can be combined with one or more features of another arrangement described herein. Thus, the breadth and scope of the present disclosure should not be limited by any of the above-described illustrative arrangements.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according arrangements of the present solution.

Additionally, memory or other storage, as well as communication components, may be employed in arrangements of the present solution. It will be appreciated that, for clarity purposes, the above description has described arrangements of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A wireless communication method comprising:
communicating, by a first network node with a second network node to determine a measurement, the measurement corresponding to a first round trip; and
transmitting, by the first network node, the measurement to a third network node.

2. The wireless communication method of claim 1, wherein the third network node comprises a user equipment (UE) or a location management function (LMF).

3. The wireless communication method of claim 1, further comprising receiving, by the first network node, control information, wherein the control information comprises information to trigger Sidelink Positioning Reference Signal (SL-PRS) transmission.

4. The wireless communication method of claim 1, wherein the measurement comprises at least one of:
a user equipment identifier (UE ID), an indication of a synchronization reference source, Sidelink Positioning Reference Signal (SL-PRS) resource information, a Rx-Tx time difference measurement, an additional path list, a timestamp, a timing quality, a SL-PRS reference signal received power (RSRP) result, a SL-PRS reference signal received path power (RSRPP) result, or a line-of-sight (LOS) or non-line-of-sight (NLOS) indicator.

5. The wireless communication method of claim 4, wherein the Rx-Tx time difference measurement, is obtained as T_{UE-RX}-T_{UE-TX},
wherein T_{UE-RX} indicates a UE received timing of sidelink subframe #i from a transmission point, defined by a first detected path in time, and T_{UE-TX} corresponds to a UE transmit timing of sidelink subframe #j that is closest in time to the subframe #i received from the transmission point.

6. The wireless communication method of claim 4, wherein the Rx-Tx time difference measurement is reported with multiple timestamps.

7. The wireless communication method of claim 4, wherein the timestamp is indicated via at least one of: direct frame number (DFN), slot number within the DFN, system frame number (SFN), slot number within the SFN, physical cell information (ID), global cell ID, or absolute radio frequency channel number (ARFCN).

8. A first network node, comprising:
at least one processor configured to:
communicate, via a transceiver with a second network node to determine a measurement, the measurement corresponding to a first round trip; and
transmit, via the transceiver, the measurement to a third network node.

9. The first network node of claim 1, wherein the third network node comprises a user equipment (UE) or a location management function (LMF).

10. The first network node of claim 1, wherein the at least one processor is configured to receive control information via the transceiver, wherein the control information comprises information to trigger Sidelink Positioning Reference Signal (SL-PRS) transmission.

11. The first network node of claim 1, wherein the measurement comprises at least one of:
a user equipment identifier (UE ID), an indication of a synchronization reference source, Sidelink Positioning Reference Signal (SL-PRS) resource information, a Rx-Tx time difference measurement, an additional path list, a timestamp, a timing quality, a SL-PRS reference signal received power (RSRP) result, a SL-PRS reference signal received path power (RSRPP) result, or a line-of-sight (LOS) or non-line-of-sight (NLOS) indicator.

12. The first network node of claim 11, wherein the Rx-Tx time difference measurement, is obtained as T_{UE-RX}-T_{UE-TX},
wherein T_{UE-RX} indicates a UE received timing of sidelink subframe #i from a transmission point, defined by a first detected path in time, and T_{UE-TX} corresponds to a UE transmit timing of sidelink subframe #j that is closest in time to the subframe #i received from the transmission point.

13. The first network node of claim 11, wherein the Rx-Tx time difference measurement is reported with multiple timestamps.

14. The first network node of claim 11, wherein the timestamp is indicated via at least one of: direct frame number (DFN), slot number within the DFN, system frame number (SFN), slot number within the SFN, physical cell information (ID), global cell ID, or absolute radio frequency channel number (ARFCN).

15. A wireless communication method, comprising:
receiving, by a third network node from a first network node, a measurement,
wherein the measurement corresponds to a first round trip and is determined via the first network node communicating with a second network node.

16. A third network node, comprising:
at least one processor configured to:
receive, via a receiver from a first network node, a measurement,
wherein the measurement corresponds to a first round trip and is determined via the first network node communicating with a second network node.

17. The third network node of claim 16, wherein the third network node comprises a user equipment (UE) or a location management function (LMF).

18. The third network node of claim 1, wherein the measurement comprises at least one of:
a user equipment identifier (UE ID), an indication of a synchronization reference source, Sidelink Positioning Reference Signal (SL-PRS) resource information, a Rx-Tx time difference measurement, an additional path list, a timestamp, a timing quality, a SL-PRS reference signal received power (RSRP) result, a SL-PRS reference signal received path power (RSRPP) result, or a line-of-sight (LOS) or non-line-of-sight (NLOS) indicator.

19. The third network node of claim 18, wherein the Rx-Tx time difference measurement, is obtained as T_{UE-RX}-T_{UE-TX},
wherein T_{UE-RX} indicates a UE received timing of sidelink subframe #i from a transmission point, defined by a first detected path in time, and T_{UE-TX} corresponds to a UE transmit timing of sidelink subframe #j that is closest in time to the subframe #i received from the transmission point.

20. The third network node of claim 18, wherein the Rx-Tx time difference measurement is reported with multiple timestamps; or
wherein the timestamp is indicated via at least one of: direct frame number (DFN), slot number within the DFN, system frame number (SFN), slot number within the SFN, physical cell information (ID), global cell ID, or absolute radio frequency channel number (ARFCN).
